(19) United States
(12) Patent Application Publication
(10) Pub. No.: US 2022/0157198 A1
(43) Pub. Date: May 19, 2022

(54) TEACHING MODEL FOR BREAST AND ABDOMINAL PROCEDURES

(71) Applicant: Caroline A. Glicksman, Brielle, NJ (US)

(72) Inventor: Caroline A. Glicksman, Brielle, NJ (US)

(21) Appl. No.: 17/521,695

(22) Filed: Nov. 8, 2021

Related U.S. Application Data
(60) Provisional application No. 63/113,788, filed on Nov. 13, 2020.

(51) Int. Cl. G09B 23/34

(52) U.S. Cl. CPC G09B 23/34

(57) ABSTRACT

A bilateral anatomical teaching model can be used for demonstrating a breast surgical procedure. The model can include a pair of pectoralis major muscle pieces and first and second breast tissue pieces. Different surgical procedures and/or complications can be demonstrated on the model together or simultaneously using both sides of the model. Such procedures and complications can include breast augmentation, window shading, breast implant revision or corrective procedures, breast reconstruction, autologous breast reconstruction, fat transfer procedures, repair of abdominal hernias, soft tissue defects, and/or abdominoplasty procedures.

### CROSS-REFERENCE TO RELATED APPLICATIONS

The present application is related to and claims the priority benefit of earlier filed U.S. Provisional Application No. 63/113,788, filed Nov. 13, 2020, the contents of which are wholly incorporated herein by reference.

### TECHNICAL FIELD

The present disclosure relates generally to models and mannequins used in the field of medicine. More specifically, the present disclosure relates to models and mannequins used in the field of medicine to teach anatomic body structure and demonstrate or simulate surgical procedures, complications, and techniques.

### BACKGROUND

An estimated 13-20 million women worldwide have undergone breast augmentation surgery in the last 40 years. In 2017 alone, there were over 300,000 breast augmentations and 129,000 breast reconstructions performed in the United States. In addition to the initial surgery, approximately 25% of breast augmentation patients will undergo an implant revision procedure within three years after having the initial surgery.

Reconstructive surgery to reconstruct the breast after a mastectomy can be performed using a breast implant, or by the use of autologous tissue harvested from the abdomen to reconstruct the absent breast or breasts. An abdominoplasty is a routine aesthetic procedure performed most often after multiple pregnancies or massive weight loss, and removes excess skin and repairs a diastasis of the rectus muscles. The American Society of Plastic Surgeons reported 129,753 abdominoplasty procedures were performed in 2017 and an estimated 500,000 hernia procedures performed.

As augmentation surgery is a cosmetic procedure, it is important that the patient be satisfied with the final outcome of their surgery. As a result, during the course of patient education, the physician attempts to provide as much information as possible to the patient regarding the specific procedures and outcomes in order for the patient to better make informed consent about the treatment. It is a known practice to use models to educate patients about the anatomic structures involved so that the patient can better understand the variety of treatment options. In addition, models can be utilized in physician education programs to teach the basic core principles of breast augmentation, revision of breast augmentation complications, and breast reconstruction with either devices or autologous reconstruction. Abdominoplasty procedures, including the repair of abdominal wall hernias, diastasis recti, and breast reconstruction using abdominal wall tissue can all be demonstrated effectively using models.

Further common surgical procedures involve surgery to the abdomen. In some instances of breast augmentation or reconstruction, the breast is accessed via the abdomen. That is, in some instances, fat and/or tissue may be transferred to the breast via the chest cavity. In other instances, patients may need direct surgery to the abdomen such as a tummy tuck or repairing a condition such as a diastasis or a hernia.

To obtain a satisfactory result, understanding and visualizing the final shape and position of the breast on the chest wall is critical to the patient who may be undergoing a breast augmentation or reconstruction. Visual demonstrations of the size of implants, positioning of implants, and the resulting appearance are critical.

### SUMMARY

In accordance with some embodiments disclosed herein is the realization that many patients need more than a single surgical procedure. For example, a woman may need a breast reconstruction on one side of the chest, a breast augmentation on the other side of the chest, and the use of autologous tissue harvested from the abdomen. In such a scenario, it is crucial for the patient to be able to visualize the three procedures on a single model as well as the associated risks and outcomes of the procedures as a whole. Therefore, it is crucial for the patient to visualize a model that represents the patient's anatomy and the associated procedures.

Current educational tools available on the market include video, as well as other visual learning tools available on the market, including photos, and drawings. However, due to the wide variation in preferred learning methods, in order to fully understand the procedures they will be undertaking, some patients may need to observe or simulate the surgical procedures on actual 3-Dimensional (3-D) model that represents their own body and can demonstrate their specific or individualized procedures or complications.

Current models fail to show an individualized anatomy for specific patients. Current models may show a single procedure, but there is a need for a model that represents a patient's specific needs for all procedures that are needed.

Accordingly, in accordance with some embodiments disclosed herein is the realization there is a need in the field for a personalized (3-D) teaching or demonstration model to show the process and finished appearance of various procedures in a single model. The various procedures may include one or more of breast augmentation procedures, reconstruction procedures, and abdominal procedures, as well as to clearly demonstrate breast implant and chest surgery complications, including, but not limited to, implant malposition, rotation of shaped devices, double bubble deformities, animation deformities associated with “window shading” of the pectoralis muscle, and asymmetries. Breast reconstruction methods that utilize the patient's own abdominal tissues, as well as repair of weaknesses of the abdominal wall, are equally difficult to explain to patients and their families.

In accordance with various embodiments of the present disclosure, a bilateral anatomical teaching model can be used for demonstrating a breast surgical procedure. The bilateral anatomical teaching model teaching model (“teaching model”) can be designed as an educational tool to enhance the hands on teaching of plastic surgery residents, and young plastic surgeons. In addition, it advantageously provides a visual three-dimensional anatomic model for use during patient consultations for procedures including, but not limited to breast augmentation, breast reconstruction, breast implant revision or corrective procedures, breast reconstruction using autologous tissue from the abdomen, fat transfer procedures, the repair of abdominal hernias and soft tissue defects, as well as aesthetic abdominoplasty procedures. Optionally, some embodiments provide a bilateral anatomical model that can allow the surgeon to educate the patient on the use of two different sized implants (one on the right and one on the left) that might be required to correct an existing or acquired breast asymmetry.

The teaching model of the various embodiments described herein is an educational tool that helps create better informed and engaged patients during pre-operative, post-operative, and at every follow-up stage or visit for years to come. For these reasons, the present disclosure represents a significant advancement in the art, which has substantial commercial merit.

In some embodiments, the teaching model can include a female-shaped torso having a chest wall. Further, teaching model can also include a pair of pectoralis major muscle pieces comprising a left pectoralis major muscle piece and a right pectoralis major muscle piece that are positionable over the chest wall surface, a first breast tissue piece that is positionable over the pectoralis major muscle piece, wherein the first breast tissue piece comprises a first pocket to accommodate an implant, and a second breast tissue piece that is positionable over the right pectoralis major muscle piece, wherein the second breast tissue piece comprises a second pocket to accommodate an implant.

In some embodiments, the anatomical teaching model may include a hook member extending from an upper portion of the female-shaped torso, and a first fabric loop coupled to the first breast tissue piece for permitting repositioning and securing of the first breast tissue piece in a folded position against the torso.

Optionally, the teaching model can further include one or more small openings (e.g., injection sites) in an outer layer of fabric of the first breast tissue piece to be used to demonstrate injection sites for how and where autologous fat may be transferred to the chest and breast. The transfer of fat to the chest and breast may be for either reconstructive or aesthetic breast procedures.

In accordance with some embodiments, the teaching model can include an abdominal skin tissue piece attachable to the rectus muscle piece, the abdominal skin tissue piece and the rectus muscle piece being displaceable away from the abdominal wall surface toward a position in which the abdominal skin flap is adjacent to the first breast tissue piece to demonstrate the autologous tissue reconstruction procedure.

Optionally, the teaching model may further include a coupling component attached to a lower, medial section of the pectoralis major muscle piece, the coupling component permitting elastic displacement of the pectoralis major muscle piece relative to the chest wall surface between a first position and a window-shaded position for demonstrating a window-shading complication. Window shading is a complication of the detachment of the sternal attachments of the pectoralis major muscle during breast reconstruction or augmentation. This leads to animation deformities and the cause and treatment may be demonstrated to the patient on the model.

The method can further include a pair of protrusions extending anteriorly from a medial section of the torso and a pair of rectus muscle pieces attachable to the torso using the pair of protrusions, the pair of rectus muscles being rotatable for demonstrating the surgical procedure or complication.

Aspects and features of the teaching models and methods disclosed herein can be provided, excluded, or modified based on the teachings and disclosure herein.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is a front view of a breast and abdominal augmentation teaching model, in accordance with some embodiments of the present disclosure.

FIG. 2A is a front view of the teaching model in FIG. 1 with the breast tissue piece and the abdominal tissue piece removed, in accordance with some embodiments of the present disclosure.

FIG. 2B is a front view of the teaching model in FIG. 1 with the abdominal tissue piece removed, in accordance with some embodiments of the present disclosure.

FIG. 2C is a front view of the teaching model in FIG. 2B demonstrating how base width is measured to determine size of an implant, in accordance with some embodiments of the present disclosure.

FIG. 2D is a front view of the teaching model in FIG. 2B demonstrating how sternal notch to nipple distance is measured to determine size of an implant, in accordance with some embodiments of the present disclosure.

FIG. 2E is a front view of the teaching model in FIG. 1 with the breast tissue piece removed and the pectoralis major muscle lifted, and the abdominal tissue removed, in accordance with some embodiments of the present disclosure.

FIG. 2F is a cross-sectional view taken along the line 2F-2F in FIG. 2B, in accordance with some embodiments of the present disclosure.

FIG. 2G is the cross-sectional view of FIG. 2F showing placement of an implant subglandular, in accordance with some embodiments of the present disclosure.

FIG. 2H is the cross-sectional view of FIG. 2F showing partial submuscular (dual plane) placement of an implant.

FIG. 3 is a front view of the teaching model in FIG. 2E illustrating an implant capsule placed under a fabric layer representing pectoralis major muscles, in accordance with some embodiments of the present disclosure.

FIGS. 4A-4D are front views of the teaching model in FIG. 2E illustrating how the teaching model may be used to demonstrate the condition of window shading, in accordance with some embodiments of the present disclosure.

FIG. 4E is condition of symmastia, in accordance with some embodiments of the present disclosure.

FIG. 5 is a front view of a breast and abdominal augmentation teaching model illustrating breast reconstruction using autologous tissue, in accordance with some embodiments of the present disclosure.

FIG. 6 is a front view of the teaching model in FIG. 2B illustrating repair to an abdominal wall surface, in accordance with some embodiments of the present disclosure.

FIGS. 7A-7C are front views of the teaching model in FIG. 2B illustrating breast reconstruction using autologous tissue, in accordance with some embodiments of the present disclosure.

FIGS. 8-9 are front views of the teaching model in FIG. 2B illustrating pegs and loops to pull the breast flap back, in accordance with some embodiments of the present disclosure.

### DETAILED DESCRIPTION

The detailed description set forth below describes various configurations of the subject technology and is not intended to represent the only configurations in which the subject technology may be practiced. The detailed description includes specific details for the purpose of providing a thorough understanding of the subject technology. Accordingly, dimensions may be provided in regard to certain aspects as non-limiting examples. However, it will be apparent to those skilled in the art that the subject technology may be practiced without these specific details. In some instances, well-known structures and components are shown in block diagram form in order to avoid obscuring the concepts of the subject technology.

It is to be understood that the present disclosure includes examples of the subject technology and does not limit the scope of the appended claims. Various aspects of the subject technology will now be disclosed according to particular but non-limiting examples. Various embodiments described in the present disclosure may be carried out in different ways and variations, and in accordance with a desired application or implementation.

The present disclosure provides a breast and abdominal augmentation and reconstruction teaching model that is believed to fill the existing void in the industry, with respect to enhancing physician-patient communication and the informed consent process. The present description relates in general to models and mannequins used in the field of medicine. More specifically, the present disclosure relates to models and mannequins used in the field of medicine to teach, illustrate, demonstrate, or simulate anatomic body structure and related surgical procedures, complications, and techniques.

The present disclosure can incorporate features disclosed in Applicant's related U.S. Pat. No. 8,568,146, filed Sep. 2, 2010, or in U.S. patent application Ser. No. 16/428,878, filed on May 31, 2019, the contents of each of which are incorporated herein by reference in their entirety.

In the present disclosure, the teaching model can comprise a life-size replica of a female torso, which can be placed on a stand or on a table. As presently designed, the chest wall of the torso can include a fabric outer surface onto which fasteners can be secured in varying locations. The fasteners and the materials that replicate the skin, soft tissues, breast parenchyma, and muscles of the chest and abdomen may be created out of fabric but could alternatively comprise a more lifelike or synthetic material.

The chest component of the teaching model is designed to be an anatomically correct replica including a female-shaped torso portion with a fabric chest wall, symmetrical pectoralis major muscle layers that can be secured to the chest wall with fasteners, and symmetrical breast tissue pieces that can be secured with fasteners over the pectoralis muscle layers. The muscle and breast tissue pieces can be made from fabric or other pliable materials.

In some embodiments, the anatomically correct model can be a bilateral anatomical teaching model. For example, the model can have a first breast piece positioned over the left pectoralis major muscle piece and a second breast tissue piece positioned over the right pectoralis major muscle piece. The bilateral anatomical teaching model may be used to teach a bilateral breast reconstruction, a bilateral breast augmentation, or one breast reconstruction and one breast reconstruction.

For example, the muscle and breast tissue pieces may be composed of an elastic type fabric that molds and contours around an implant replicating the shape, position, and feel of a breast augmentation, breast reconstruction, or revision breast procedure. Alternately, a synthetic material may be used that may be more durable than the elastic-type of fabric. Available samples of actual breast implants may be utilized by the clinician to demonstrate the placement of the implants in various pockets, including subglandular or dual plane (partial submuscular) placements. The breast tissue, and muscle layers can be elevated to reveal the deeper tissue layers if desired.

In accordance with some embodiments, various fasteners may be used to removably attach the pectoralis major muscle layers to the torso at several positions including along the sternal border, clavicle and axilla. The fasteners may also be positioned along the anterior axillary line. The fasteners may attach the pectoralis major muscles superiorly along the clavicle, medially along the length of the sternum, and laterally in the superior axilla near the humeral head. In some embodiments, the inferior-lateral attachments are free, and not attached to the torso of the mannequin.

In accordance with some embodiments, the model can comprise a hook member, which can extend from an upper portion of the female-shaped torso of the teaching model. The hook member may be a peg, a pin, a clip, or a clasp. In some embodiments, fabric loops may be attached to a first breast tissue piece. In this example, the fabric loop engages the hook member extending from an upper portion of the female-shaped torso and allows repositioning and securing of the first breast tissue piece.

The breast tissue pieces may optionally include anterior and posterior fabric surfaces coupled to each other and filled with a batting material therebetween to represent the adult female breast. In some embodiments, the breast tissue pieces may include an anatomically correct nipple-areola. Similar to the muscle layers, various fasteners may be used to removably attach the breast tissue pieces to the torso at several positions.

In some embodiments, the teaching model may optionally include a strip or other piece of fabric attached to the torso at a position so as to represent the original or current inframammary fold. The fabric representing the inframammary fold may be attached to the torso using any of the fasteners described above. An additional fastening means may be present inferior to the inframammary fold to demonstrate a possible lower inframammary fold (referred to above as the current inframammary fold) that may develop during or after surgery.

In accordance with various embodiments of the present disclosure, an abdominal component can optionally be attached to the abdominal portion of the torso using one or more fasteners. The torso surface can represent the abdominal wall deep to the paired rectus abdominus muscles. The two paired rectus abdominus muscles can be attached to the abdominal wall and manipulable to modify a position of the two paired rectus abdominus muscles, laterally, superiorly, and inferiorly. The two paired rectus abdominus muscles can be brought close together to demonstrate normal abdominal wall anatomy, or separated to represent a diastasis recti or separation of the abdominal wall muscles or abdominal wall hernia.

In some embodiments, the paired rectus abdominus muscles may be secured by one or more pegs inferior to the sternum in order to facilitate the movement of the muscle. For example, the pegs may allow for full rotation to demonstrate autologous breast reconstruction.

In some embodiments, there may optionally be an umbilicus attached to the teaching model in the correct anatomical position, fabricated of a synthetic material. The abdominal component can be used to further educate patients, medical students and residents on the use of Acellular Dermal Matrix (ADM) or scaffolds to provide soft tissue support to abdominal wall defects, hernias, and aesthetic repair in abdominoplasty.

The rectus muscle may optionally be elevated, based superiorly on fasteners, and/or detached inferiorly, as would occur in a surgical procedure. Further, the rectus muscle may be rotated superiorly with attachable overlying soft tissue material and skin into the contralateral chest to demonstrate autologous breast reconstruction. The mastectomy component of the teaching model may be configured in a similar fashion as the breast-teaching component. Optionally, the soft fabric batting may be omitted or removed from a pocket within the fabric layers of the breast to represent the loss of breast tissue after a mastectomy.

In some embodiments, an abdominal skin tissue piece is attachable to the rectus muscle piece. The abdominal skin tissue piece and the rectus muscle piece are displaced away from the abdominal surface wall. The abdominal skin tissue piece and the rectus muscle piece can be directed toward a position in which the abdominal skin flap is adjacent to the first breast tissue piece to demonstrate the autologous tissue reconstruction procedure.

In some embodiments, the teaching model includes one or more injection sites to demonstrate injection sites for an autologous fat transfer procedure.

In some embodiments, the teaching model can include a coupling component attached to a lower, medial section of the pectoralis major muscle piece. The coupling component can permit elastic displacement of the pectoralis major muscle piece relative to the chest wall surface. The coupling component may be a lanyard cable system and may demonstrate the window-shading complication.

Optionally, the lanyard cable system can be used to educate the patient on the importance of selecting an implant that is sized best for their chest anatomy to reduce the chances of cutting through the pectoralis major muscle causing it to retract.

The teaching model, whether it includes both the breast and abdominal components or not, may be used as a teaching tool for physicians to demonstrate and educate patients about what occurs during breast and abdominal procedures and possible complications resulting from such procedures.

It can therefore be seen that the teaching model with the modifications described to include an abdominal teaching component is an important tool that can improve both patient and physician education in breast augmentation and breast reconstruction that may lead to improved surgical outcomes and reduced reoperation rates. An improved educational experience may help patients become better informed and therefore better able to make informed consent. As noted above, the teaching model is designed as an educational tool to enhance the hands on teaching of plastic surgery residents, and young plastic surgeons. In addition, it advantageously provides a visual three-dimensional anatomic teaching model for use during patient consultations for procedures including, but not limited to breast augmentation, breast reconstruction, breast implant revision or corrective procedures, breast reconstruction using autologous tissue from the abdomen, fat transfer procedures, the repair of abdominal hernias and soft tissue defects, as well as abdominoplasty procedures. The teaching model of the various embodiments described herein is an educational tool that helps create better informed and engaged patients during pre-operative, post-operative, and at every follow-up stage or visit for years to come. For these reasons, the present disclosure represents a significant advancement in the art, which has substantial commercial merit.

The teaching model, including its various embodiments described herein, was studied, demonstrated, and indicated as an effective educational tool through a study sponsored by the Aesthetic Society Educational Research Foundation (ASERF). In particular, the study was conducted by Dr. Caroline Glicksman and demonstrated that embodiments of the teaching model are an effective tool in educating potential primary breast augmentation and revision-augmentation patients, office staff, and residents and/or medical students regarding various surgical procedures, their complications, appropriate care, and potential outcomes.

### A Study Regarding Efficacy of the Teaching Model

The study was designed to evaluate the effectiveness of using embodiments of the teaching model during a 15-20 minute counseling session to define terms and procedures related to primary and revision breast augmentation procedures. The efficacy of the teaching model was then evaluated via a questionnaire designed with a Likert-type scale. The questionnaire evaluated how subjects from each of the three groups felt about their level of education on a variety of concepts related to primary and revision breast augmentation procedures after counseling using the teaching model.

The following three groups were studied: Group 1—potential primary breast augmentation and revision-augmentation patients; Group 2—staff, such as medical assistants, nurse educators, and surgical coordinators; and Group 3—residents or medical students in an accredited plastic surgery program. All three groups were educated using the teaching model and an educational video that demonstrated the teaching model. The three groups were then asked to complete a questionnaire seeking feedback on how effective the teaching model was in demonstrating the concepts indicated in Tables 1 and 2 below. The goal was to obtain at least 25 completed questionnaires in each of the three groups.

Results for the study are represented in Tables 1 and 2 below:

TABLE 1
Was the Teaching Model
Effective in Demonstrating the Following Concepts?

| | | | Neither | | |
|---|---|---|---|---|---|
| | | | Agree | | |
| | Strongly | Dis- | nor | | Strongly |
| Concept Demonstrated | Disagree | agree | Disagree | Agree | Agree |
| Subglandular implant placement | | | 2 | 10 | 40 |
| Submuscular implant placement | | | | 7 | 45 |
| Dual plane implant placement | | | 1 | 10 | 41 |
| Anatomic location of the | | | 2 | 10 | 40 |
| Pectoralis major and minor | | | | | |
| Anatomic location of the sternum | | | | 13 | 38 |
| and where the muscle attaches | | | | | |
| Why the patient's anatomy | | 1 | | 7 | 44 |
| predicts the amount of possible | | | | | |
| “Base width” measurement of the | | | | 8 | 44 |
| breast | | | | | |
| Importance of selecting an | | | | 5 | 47 |
| implant that fits the patient's base | | | | | |
| width measurement | | | | | |
| How and where an implant might | | | | 16 | 36 |
| be palpated (felt) after breast | | | | | |
| augmentation | | | | | |
| How to avoid oversizing an | | | | 6 | 46 |
| implant | | | | | |

TABLE 2
Was the Teaching Model
Effective in Demonstrating the Following Concepts?

| | | | Neither | | |
|---|---|---|---|---|---|
| | | | Agree | | |
| | Strongly | Dis- | nor | | Strongly |
| Concept Demonstrated | Disagree | agree | Disagree | Agree | Agree |
| What a breast implant capsule is | | | | 9 | 43 |
| Meaning and effects of capsular | | | | 12 | 40 |
| contracture | | | | | |
| Steps taken in the operating room | | 1 | | 6 | 45 |
| to avoid pocket contamination | | | | | |
| Possible incision locations and | | | | 11 | 41 |
| their size | | | | | |
| Where an implant pocket will be | | 1 | | 6 | 45 |
| made | | | | | |

The above Tables 1 and 2 provide the results of the survey taken by participants of the three test groups previously described. As illustrated in Tables 1 and 2 above, the teaching model of the present disclosure has a demonstrated extraordinary and surprising effectiveness in educating plastic surgery patients, staff, residents and medical students on a variety of concepts related to a breast augmentation.

As shall be described in further detail below, it can therefore be seen that the teaching model is an important tool that can improve both patient and physician education in primary and revision breast augmentation as well as breast reconstruction procedures. As a result, the teaching model can substantially improve surgical outcomes, reduce reoperation rates, and set appropriate patient expectations, all of which are critical factors in evaluating the success of a procedure. An improved educational experience may help patients become better informed and therefore better able to make informed consent. The teaching model is designed as an educational tool to enhance the hands-on teaching of plastic surgery residents and young plastic surgeons. In addition, it advantageously provides a visual three-dimensional anatomic model for use during patient consultations for procedures including, but not limited to, breast augmentation, breast reconstruction, breast implant revision or corrective procedures, breast reconstruction using autologous tissue from the abdomen, fat transfer procedures, the repair of abdominal hernias and soft tissue defects, and/or abdominoplasty procedures. The teaching model of the various embodiments described herein is an educational tool that helps create better informed and engaged patients, whether the stage is pre-operative, post-operative, or at every follow-up visit for years to come. For these reasons, the present disclosure represents a significant and important advancement in the art that has substantial commercial merit.

### Description of Embodiments of the Teaching Model

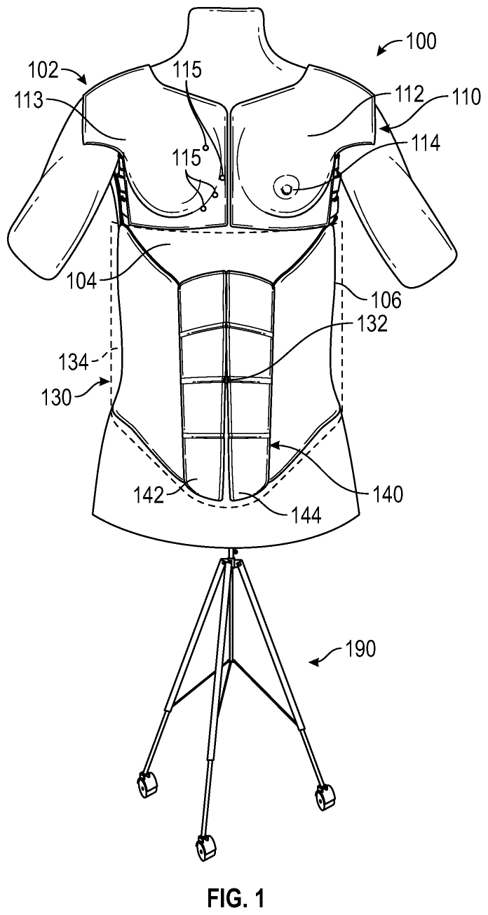

FIG. 1 is a front view of a breast and abdominal augmentation teaching model 100 in accordance with some embodiments of the present disclosure. According to various embodiments of the present disclosure, the teaching model 100 may include a female-shaped torso 102 including a chest wall surface 104 and an abdominal wall surface 106.

In some embodiments, the female-shaped torso 102 includes an outer layer of fabric representing an outer layer of skin (not shown). In some embodiments, the outer layer of fabric is made from a stretchable material. In some embodiments, the outer fabric layer comprises of two layers to demonstrate a pocket. In some embodiments, the two layers of fabric includes fabric to represent soft tissue.

In some embodiments, the breast and augmentation model comprises a bilateral model illustrating two breasts. In some embodiments, the model allows for a physician to demonstrate specific measurements.

For example, the model can allow for demonstration of sternal notch to nipple-areola distance, nipple to inframammary fold, circumference of the breast, and base width based on the patient's anatomy. In some embodiments, the female-shaped torso may have a breast base of about 8 cm to about 16 cm, about 10 cm to about 14 cm, or about 12.0 cm. Further, some embodiments can comprise a sternal notch to nipple-areola distance of about 14 cm to about 30 cm, about 16 cm to about 28 cm, about 18 cm to about 26 cm, about 20 cm to about 24 cm, or about 22.0 cm to accommodate the most commonly used breast implants. The model may include a pocket to accommodate an implant subglandularly or submuscularly. In some embodiments, the female-shaped torso may have a breast base larger than 12.0 cm and a nipple-areola distance of greater than 22.0 cm. In some embodiments, the teaching model 100 appears as a life size replica of a female torso, which can be placed on a stand or on a table. In other embodiments, however, as illustrated in FIG. 1, the teaching model 100 may be positioned on a stand such as a tripod stand 190 having wheels for ease of transportation of the teaching model 100 to various locations where the demonstrations will be performed. The chest wall surface 104 of the female-shaped torso 102 may be a fabric surface onto which fasteners can be used to secure one or more illustrative components (discussed below) to the torso 102 in various locations. The fasteners and the materials that replicate the skin, soft tissues, breast parenchyma, and muscles of the chest and abdomen may be created out of fabric but could alternatively comprise a more lifelike or synthetic material.

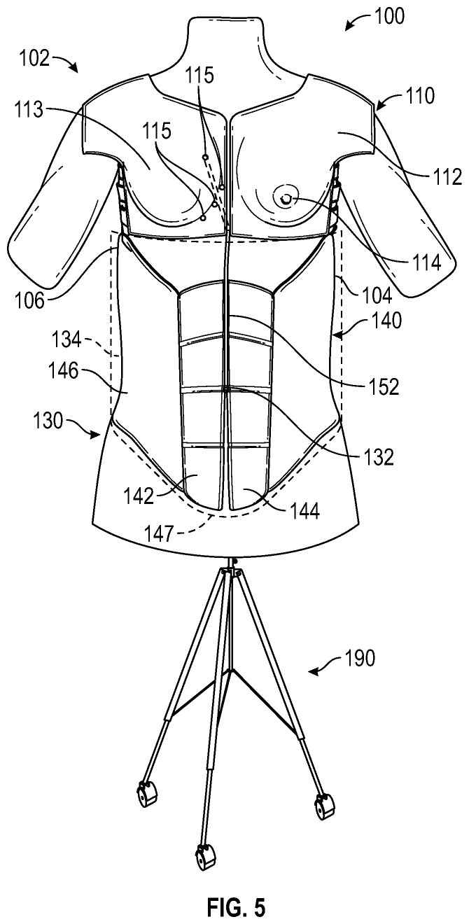

In accordance with some embodiments, the teaching model 100 may include a breast component 110 having an augmentation breast tissue piece 112, a mastectomy breast tissue piece 113, and an abdominal component 130 that are secured onto a fabric cover representing a female-shaped torso 102. The mastectomy breast piece 113 may have decreased to no filling material therein to demonstrate a breast on which a mastectomy has been performed, and from which breast tissue has been removed. In some embodiments, as shall be illustrated in further detail with respect to FIG. 5, teaching model 100 may be used to demonstrate a procedure in which the autologous fat may be injected into breast tissue directly at the breast level. Accordingly, the mastectomy the breast tissue piece 113 may include one or more injection sites 115 for demonstrating where fat may be introduced into the mastectomy breast tissue piece 113 to add volume and correct soft tissue defects. As shall be described in further detail below, the typical locations used to inject fat into the breast or chest are along the inframammary fold and the lateral and superior breast and chest.

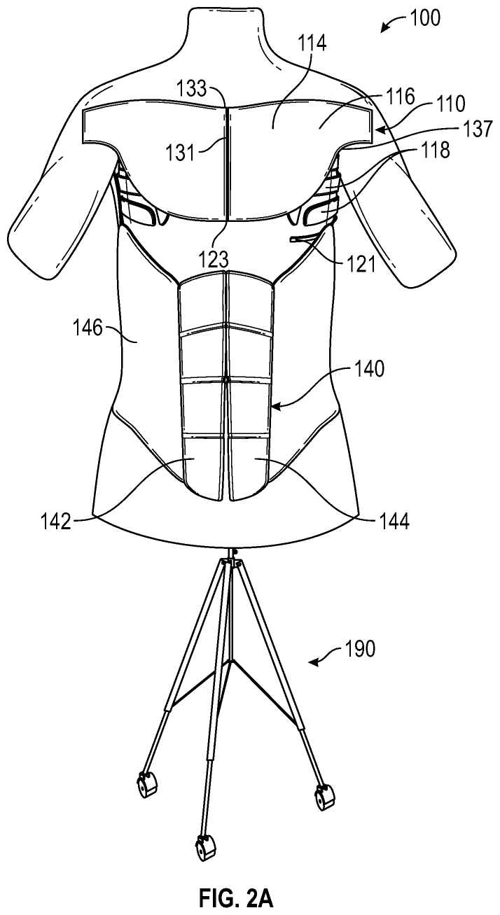

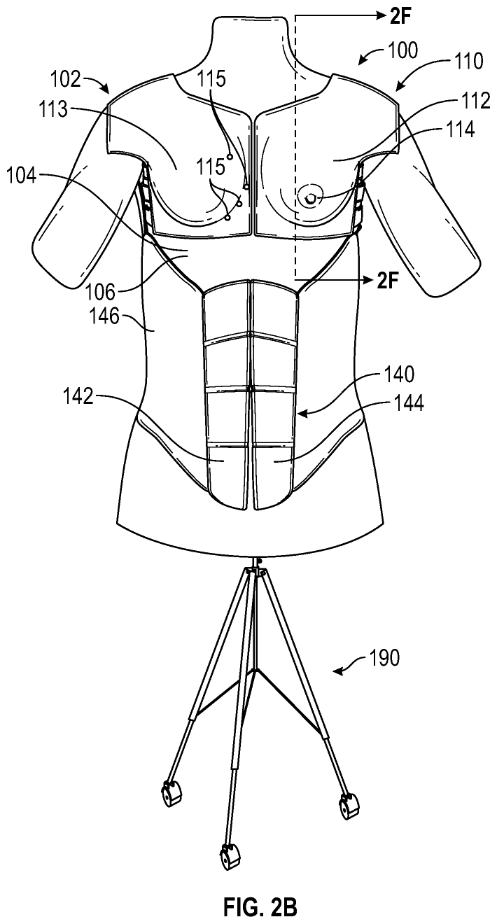

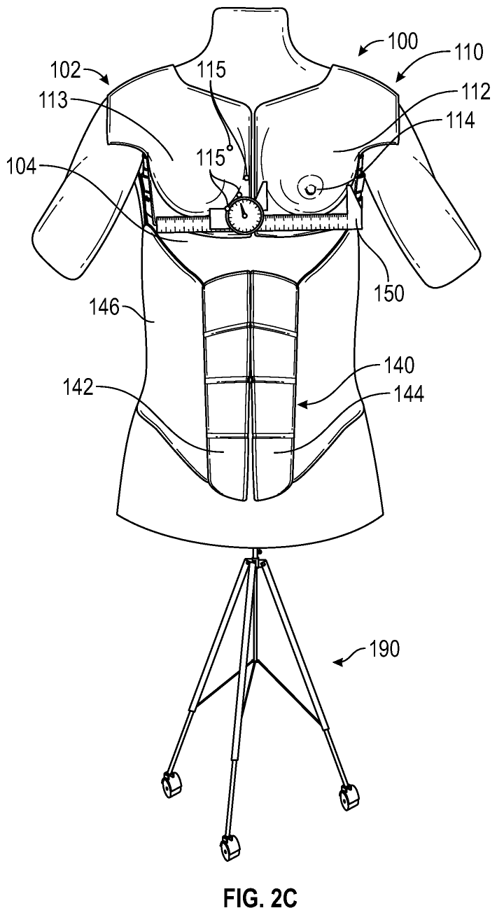

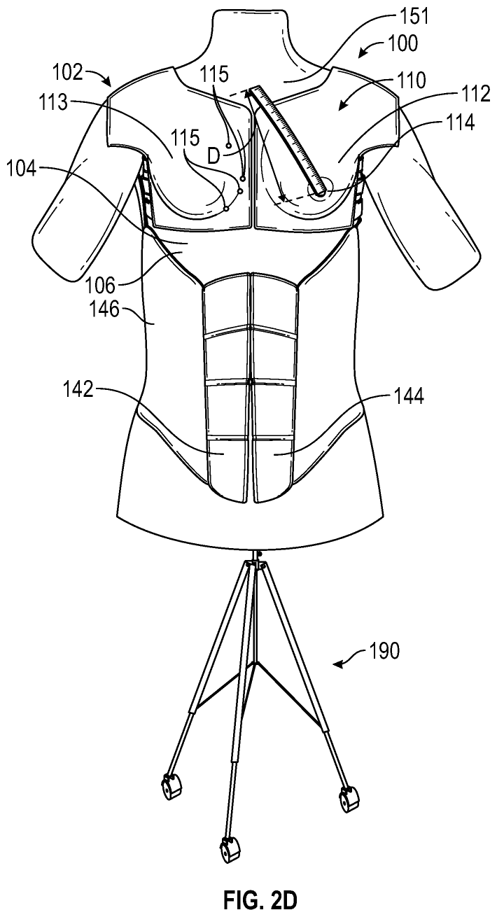

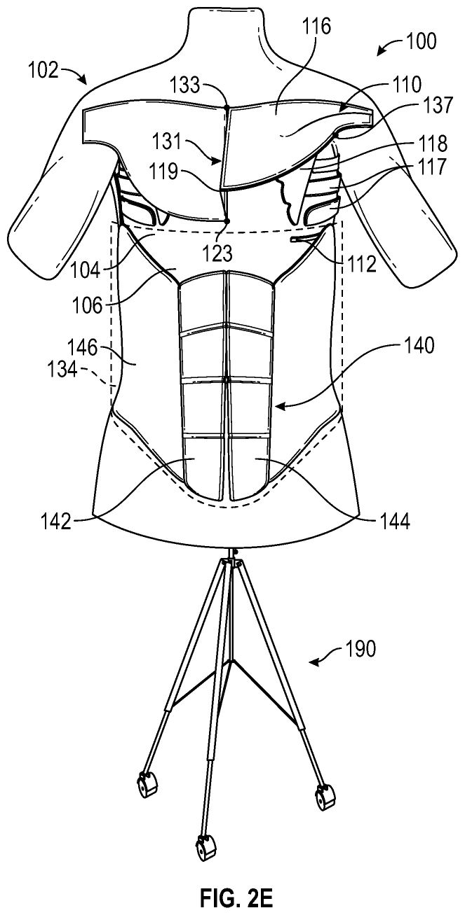

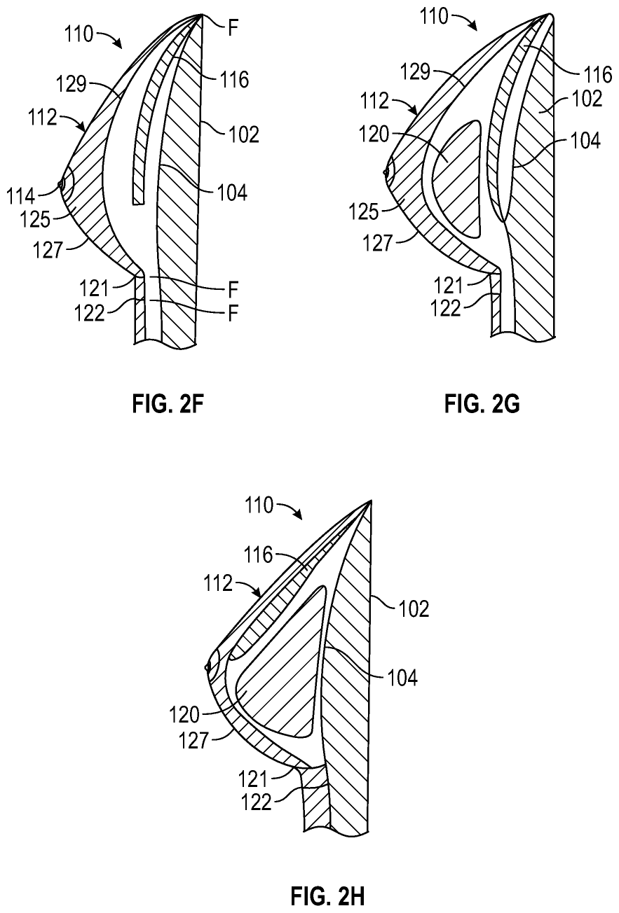

The breast tissue pieces 112 may be formed of anterior and posterior fabric layers 127 and 129 (illustrated in FIGS. 2F-2H) coupled to each other and filled with a batting or other soft tissue filling 125 (illustrated in FIGS. 2F-2H) to represent the adult female breast with an anatomically correct nipple-areola 114. As illustrated in FIG. 1, the abdominal component 130 may include an abdominal tissue piece 134 which may similarly be formed of anterior and posterior fabric layers coupled to each other and filled with a batting or tissue material to represent a female abdomen.

Fastening of the various layers can be accomplished using tethering fasteners, hook and loop fasteners, snap fasteners, and/or grommet fasteners. However, it should be appreciated by one skilled in the art that a variety of different fasteners may also be used to accomplish the underlying goals of the present disclosure, such as, but not limited to, hooks, buttons, and other similar fastening mechanisms.

As a teaching tool for physicians, hospital or clinic staff, medical students, and residents, embodiments of the teaching model disclosed herein can be used to demonstrate a variety of different conditions and procedures relating to augmentation and reconstruction, understanding of round versus shaped devices in augmentation and reconstruction and an understanding of how to avoid and revise the most common breast implant malposition and sizing complications. As a teaching tool for patients, the teaching model can be used to demonstrate the differences between subglandular and dual plane breast augmentation, biodimensional tissue based breast augmentation and reconstruction, breast implant complications, including, but not limited to: malposition deformities, palpability, visibility, capsular contracture, over sizing and under sizing of breast implants, rotation of shaped implants, the different appearance of round and shaped breast implants and the utilization of adjunct procedures, such as acellular dermal grafts and fat transfer in augmentation and reconstruction.

FIG. 2A is a front view of the teaching model in FIG. 1 with the breast tissue piece 112 and the abdominal tissue piece 134 removed, in accordance with some embodiments of the present disclosure. FIG. 2B is a front view of the teaching model in FIG. 1 with the abdominal tissue piece 134 fully detached, in accordance with some embodiments of the present disclosure. As illustrated in FIGS. 2A and 2B, the abdominal component 130 may be moveable, detachable, and repositionable relative to the abdominal wall surface 106 and the breast component 110. In accordance with some embodiments of the present disclosure relative positions of the abdominal component 130 and of the and the breast component 110 are manipulable on the female-shaped torso to permit a clinician to demonstrate at least one of breast structure of the female anatomy, surgical procedures performed on the female anatomy, and/or adverse body conditions resulting from the surgical procedure.

This configuration may be achieved using a variety of fasteners, e.g., hook and loop fasteners, grommet fasteners, snap fasteners, or any other similar fastening devices. In particular, the abdominal tissue piece 134 may be attached or affixed to the fabric cover of the torso 102 using any one or more of the aforementioned fasteners in order to reveal the underlying anatomy. As depicted, the underlying anatomy may include a rectus muscles fabric layer including paired rectus muscles 142, 144. The rectus muscles fabric layer having paired rectus muscles 142, 144 may comprise two sections of material symmetrically disposed about a sagittal plane of the torso 102.

Educating a Patient about Implant Size Considerations (Bio-Dimensional Planning Using the Teaching Model)

FIG. 2C is a front view of the teaching model in FIG. 2B demonstrating how base width is measured to determine size of an implant, in accordance with some embodiments of the present disclosure. FIG. 2D is a front view of the teaching model in FIG. 2B demonstrating how a sternal-notch-to-nipple distance is measured to determine size of an implant, in accordance with some embodiments of the present disclosure. In accordance with various embodiments of the present disclosure, the teaching model 100 may be used to educate patients with respect to size limits of the implant to be placed in the patient's chest cavity.

For example, the teaching model 100 may be used to demonstrate how a base width measurement is taken in order to determine an appropriate size of the implant. As depicted in FIG. 2C, a measurement device (e.g., calipers or a measurement tape) 150 may be positioned on the breast tissue piece 112 so as to measure how wide the breast is from side to side. The teaching model 100 may further be used to demonstrate how a suprasternal notch to nipple measurement is taken to determine an appropriate size of the implant. As depicted in FIG. 2D, a measurement device 151 (e.g., a tape measure or a flexible ruler) may be positioned on the breast tissue piece 112 so as to measure a distance D from the nipple 114 to the suprasternal notch in the area of the collar bone. Based on these measurements, a patient may be educated on potential size limits of the implant to be chosen based on the patient's anatomical measurements thereby avoiding a situation where the patient requests an inappropriately large size of implant which could potentially lead to complications or further issues in the future. Thus, the patient can understand using the teaching model 100 that the implant cannot be chosen merely based on how wide or large the patient would like the implant to be, but that instead the measurements of the implant need to be based upon the patient's anatomy.

With the teaching model 100, individual bodily limits with regard to implant size and breast positioning and shape can be demonstrated to, and understood by patients, medical staff and students in training, as well as other staff involved in educating and communicating with patients.

For example, the teaching model 100 can be used to demonstrate that a position where the pectoralis major muscle piece 116 terminates on the female-shaped torso 102 corresponds to where the implant 120 should terminate. The teaching model 100 may also be used to educate the patient that the end or edge of the chest wall surface 104 of the female-shaped torso corresponds to where the boundary of the implant should be unless a patient wants to experience some of the complications known as visibility or palpability when an implant is placed beyond breast and into the very thin overlying soft tissues.

### Demonstration of Female Anatomy Using the Teaching Model

FIG. 2E is a front view of the teaching model in FIG. 1 with the breast tissue piece 112 lifted, and the abdominal tissue piece removed, in accordance with some embodiments of the present disclosure. As depicted, the anatomical teaching model 100 may further include a pectoralis major muscle piece 116 attachable to the chest wall surface 104. The pectoralis major muscle piece 116 may be positioned to sit under the breast tissue piece 112. Relative positions of the pectoralis major muscle piece 116 and of the breast tissue piece may be manipulable to permit a clinician to demonstrate a female anatomy, a surgical procedure to the female anatomy, and/or a condition resulting from the surgical procedure.

In some embodiments, the breast tissue piece 112 attaches to the pectoralis major muscle piece 116. In particular, the breast tissue piece 112 may removably attach to the pectoralis major muscle piece 116 using at least one fastener F (illustrated in FIG. 2F). The fastener F may be selected from the group consisting of a hook and loop fastener, a grommet fastener, a snap fastener, and a combination thereof.

Similar to the breast tissue piece 112, various fasteners 131, 133, 137 may be used to removably attach the pectoralis major muscle fabric piece 116 to the torso 102 at several positions. For example, the pectoralis major muscle fabric piece 116 may be attached to the fabric cover of the torso 102 along the sternal border (e.g. using tethered fastener 123), the clavicle (e.g., using fastener 133) and the axilla (e.g., using fastener 137). The fasteners may also be positioned along the anterior axillary line.

In some embodiments, the fasteners may attach the pectoralis major muscle fabric piece 116 superiorly along the clavicle, medially along the length of the sternum, and/or laterally in the superior axilla near the humeral head. In some embodiments, the inferior-lateral attachments may be free, and not attached to the female-shaped torso 102 so as to allow folding and flipping over of the breast tissue piece 112 and the pectoralis major muscle fabric piece 116, as well as insertion of implant 120 into a cavity defined between the pectoralis major muscle fabric piece 116 and the chest wall surface 104. Although only one pectoralis major muscle fabric piece 116 may be illustrated in some embodiments for the sake of clarity, the various embodiments of the present disclosure are not limited to the aforementioned configuration. For example, the teaching model 100 may include two pectoralis major muscle fabric pieces 116 symmetrically disposed about a sagittal plane of the female-shaped torso 102.

According to various embodiments of the present disclosure, the anatomical teaching model 100 may further include a pair of rectus muscle pieces 142, 144 that is attachable to the abdominal wall surface 106. The pair of rectus muscle pieces 142, 144 may be two sections of material that are positionable symmetrically about the sagittal plane of the female-shaped torso 102.

Optionally, in some embodiments, the teaching model 100 may further include an abdominal tissue piece 134 (illustrated in FIG. 1) positionable over the pair of rectus muscle pieces 142, 144.

In accordance with some embodiments, the abdominal tissue piece 134 may attach to at least one of the pair of rectus muscle pieces 142, 144 or to the abdominal wall surface 106. For example, the abdominal tissue piece 134 may attach to at least one of the pair of rectus muscle pieces using at least one fastener selected from the group consisting of a hook and loop fastener, a grommet fastener, a snap fastener, and a combination thereof.

The pectoralis major muscle piece 116, the breast tissue piece 112, and/or the pair of rectus muscle pieces 142, 144 may be formed of a stretchable fabric material. In some embodiments, the pectoralis major muscle piece 116, the breast tissue piece 112, and/or the pair of and the pair of rectus muscle pieces 142, 144 are formed of a synthetic material. Such embodiments can advantageously provide a stretching capability for the materials of components of the teaching model 100 described herein, which can be helpful to illustrate features of procedures and anatomy.

As shall be described in further detail below, relative positions of the pair of rectus muscle pieces 142, 144, and the abdominal tissue piece 134 are manipulable to permit a clinician to demonstrate at least one of a female anatomy, a surgical procedure to the female anatomy, or a condition prompting or resulting from the surgical procedure.

According to various embodiments of the present disclosure, the teaching model 100 may include a pectoralis minor muscle piece 118 removably attachable to the chest wall surface 104. As depicted in FIG. 2E, the pectoralis minor muscle piece 118 may be positioned underneath the pectoralis major muscle piece 116. In some embodiments, a serratus muscles piece 117 may be positioned adjacent to the pectoralis minor muscle piece 118 and removably attached to the chest wall surface 104 in a similar manner to the pectoralis minor muscle piece 118. As depicted, the serratus muscle piece 117 may be positioned at least partially underneath the pectoralis major muscle piece 116.

The teaching model 100 may further include an original inframammary fold fabric 121 removably attached to the chest wall surface 104 at a position on the female-shaped torso 102 between the pectoralis major muscle piece 116 and the pair of rectus muscle pieces 142, 144. In accordance with some embodiments, the inframammary fold 121 may alternatively be written, painted or otherwise marked onto the female-shaped torso. In some embodiments, a second inframammary fold 122 (illustrated in FIG. 2F) may be positioned on the female torso 102 to demonstrate a condition in which placements of the inframammary fold may be adjusted during a surgical procedure.

FIG. 2F is a cross-sectional view taken along the line 2F-2F in FIG. 2B, in accordance with some embodiments of the present disclosure. As depicted in FIG. 2F, the anatomic breast tissue piece 112 may be formed of two fabric layers 127 and 129 coupled to each other with a soft compressible filling 125 positioned between the two fabric layers 127 and 129.

In accordance with some embodiments, the two fabric layers 127 and 129 may respectively represent an anterior skin surface and a deep layer of the breast tissue piece 112. As previously discussed above, pectoralis major muscle piece 116 and breast tissue piece 112 may be attached to the female-shaped torso using at least one of the aforementioned fasteners. This allows the teaching model 100 to be used repeatedly to demonstrate various breast surgical procedures and associated complications including, but not limited to breast augmentation, breast reconstruction, breast implant complications and breast implant revision or corrective procedures.

Educating a Patient about the Location of the Implant

FIG. 2G is the cross-sectional view of FIG. 2F showing placement of an implant 120 subglandular, in accordance with some embodiments of the present disclosure. FIG. 2H is the cross-sectional view of FIG. 2F showing partial submuscular (dual plane) placement of an implant 120. As depicted in FIGS. 2F and 2G, currently available breast implants 120 may be utilized by the clinician to demonstrate the placement of the implants 120 in various pockets of the body.

For example, the clinician may use the teaching model 100 to demonstrate a subglandular positioning of the implant where the implant 120 is positioned sitting beneath the breast tissue piece 112 and the gland as depicted in FIG. 2G. The clinician may use the teaching model 100 to demonstrate a partial submuscular (dual plane) positioning of the implant where the implant 120 is positioned partially beneath the pectoralis major muscle piece 116 and partially beneath the gland. The breast tissue piece 112 and the pectoralis major muscle piece 116 can each be stretched or elevated to reveal the deeper tissue layers if desired.

The model may include a pre-pectoral major pocket within the layers of the fabric of the breast flap to accommodate a breast implant and to demonstrate subglandular breast augmentation and pre-pectoral breast reconstruction.

Educating the Patient about Immediate and Delayed Breast Reconstruction

A contralateral breast may be added for the demonstration of immediate and delayed breast reconstruction. In some embodiments, the model includes a second, contralateral breast to allow the demonstration of bilateral procedures. The contralateral breast may provide more detailed instructions on breast reconstruction using autologous tissue including fat and symmetrizing procedures.

In some embodiments, the model can be used to provide a demonstration of a breast augmentation on one side, and a breast reconstruction on the opposite side. In some embodiments, the model can be used to provide a demonstration of a bilateral breast augmentation. In some embodiments, the model includes a demonstration of a bilateral breast reconstruction.

The use of the model need not be limited by the structural components of the breast on either side, but can instead be a teaching model a patient or surgeon. For example, one patient may have a need for different procedures on each side (e.g., breast augmentation on the left side, breast reconstruction on the right side, and an abdominal hernia). In this example, a model is provided that teaches the procedure, risks, and outcomes of all three procedures. Advantageously then, the model can illustrate several procedures so that each patient can see a physical model of their unique situation.

Educating a Patient about Breast Surgery Complications and Revision Surgery to Correct Complications

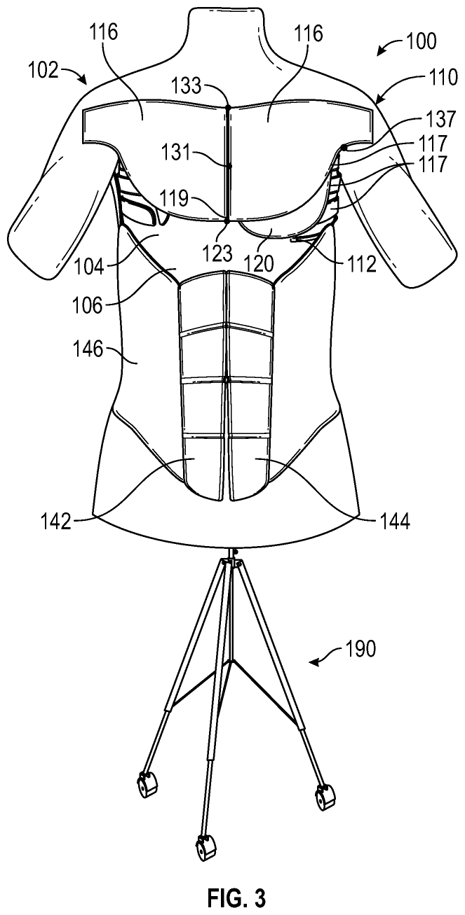

FIG. 3 is a front view of the teaching model in FIG. 2E illustrating an implant capsule placed under a pectoralis major muscle piece 116, in accordance with some embodiments of the present disclosure. The fabric implant capsule represents the layer of scar tissue that forms around an implanted breast device shortly after implantation. All patients with breast implants form a capsule and this fabric capsule used with the model aids in the demonstration of revision procedures.

As depicted, the pectoralis major muscle piece 116 may be attached at a lower portion or edge 119 thereof to the chest wall surface 104. In particular, the pectoralis major muscle piece 116 may be tethered at an inferior aspect thereof (represented by the lower portion or edge 119) to the chest wall surface 104 in order to demonstrate situations and complications which routinely occur as a result of breast surgery.

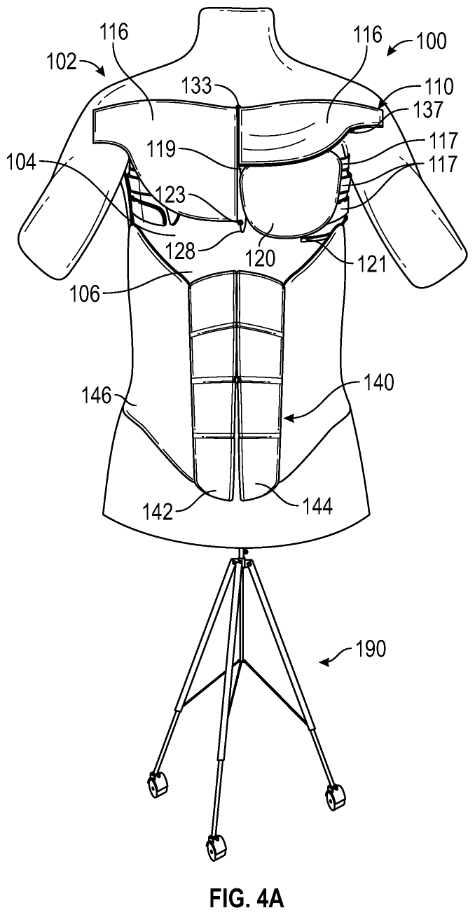

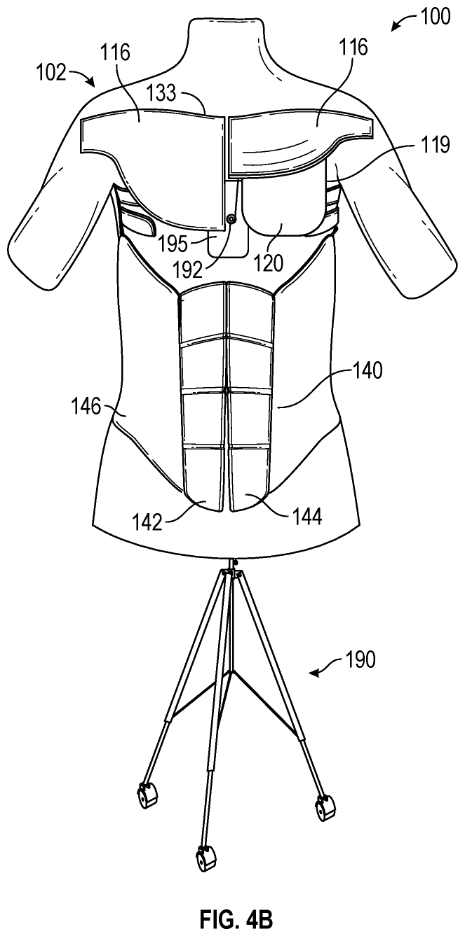

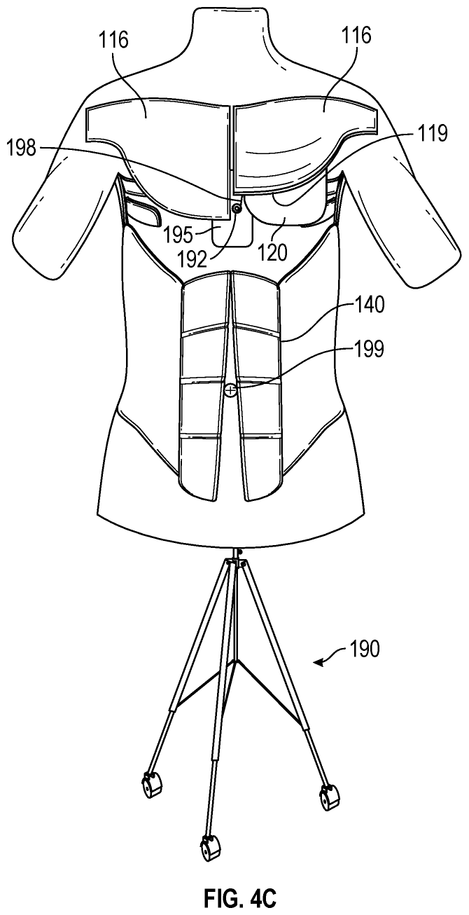

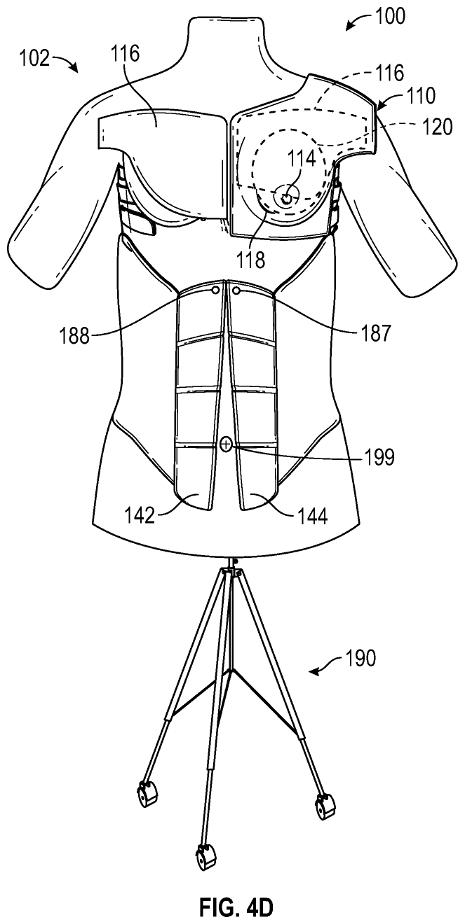

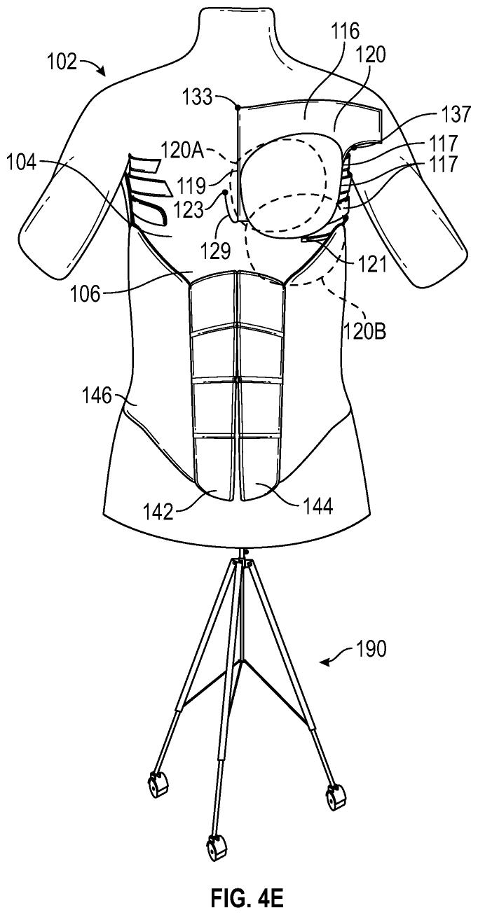

For example, a tether fastener 123 may movably and detachably couple the pectoralis major muscle piece 116 to the chest wall surface 104. The tether fastener 123 may include an elastic string portion 128 (illustrated in FIGS. 4A-4C) which may allow the pectoralis major muscle piece 116 to be pulled away from the chest wall surface 104 without completely detaching therefrom. The aforementioned tether fastener is advantageous in that it allows for a volume of a cavity between the chest wall surface 104 and the pectoralis major muscle piece 116 to be variably increased depending on a size of the implant 120 to be inserted therein.

Educating a Patient about Window Shading

FIGS. 4A-4C is a front view of the teaching model in FIG. 2E illustrating how the teaching model 100 may be used to demonstrate the condition of window shading, in accordance with some embodiments of the present disclosure. The teaching model 100 may be used to demonstrate the condition of window shading where the pectoralis major muscle pieces 116 have been cut or otherwise divided and retracts back, and an implant 120 underneath the lifted pectoralis major muscle pieces 116 sits exposed. As illustrated in FIG. 4A, the implant 120 may be located in the correct position, but the pectoralis major muscle pieces 116 may be “window-shaded” or pulled superiorly (pulled upwards) as a result of being cut during surgery. Due to the decreased or lack of surface area coverage of the pectoralis major muscle piece 116 on the chest wall surface 104, the implant may be palpable and visible through the skin.

### Cable System for Demonstrating Complications and Visualizing Deep Tissue Layers

A cable system may be included in the anatomical model in order to demonstrate complications that may occur from a breast surgical procedure and to visualize deeper tissue layers. The cable system may attach to a breast tissue piece to allow movement of that breast tissue piece.

FIG. 4B illustrates an example of a cable system in a front view of the teaching model in FIG. 2E to demonstrate the condition of window shading by using a cable system (e.g., tethered fastener). As discussed herein, the cable system and a tethered fastener can be used interchangeably. The teaching model 100 can include a cavity 195 between pectoralis major pieces 116 that houses the cable system and tethered fastener.

The cavity may be disposed into the model, such that the cable system sits flush with the surface of the model. The cable system may include a circular component disposed into the cavity in which the tethered fastener is configured to be wound around the circular component. In some embodiments, the circular component is made out of plastic, metal, rubber, or any reasonable material.

In some embodiments the cavity 195 is disposed into the model and can accommodate a cable 198. The cable 198 may be string, plastic, rubber, metal, or any reasonable material. The cavity 195 may also include a cover (not shown), such that the cover is flush with the surface of the model. In some embodiments, the cover also includes a small hole with a diameter that is slightly larger in diameter than the diameter of the cable 198 such that the cable may be pulled through the cover without removing the cover. In some embodiments, the cable system includes a tether ring 192, and the cable 198 can be wound around the tether ring 192.

Upon pulling the cable 198 through the cover, the tether ring 192 may spin which causes the cable 198 to unwind from the tether ring 192. In some embodiments, the cable 198 is unwound from the tether ring 192 as tension is applied across the cable 198 and pulls the pectoralis major muscle piece 116 towards an upper portion of the female shaped torso 102. In some embodiments, the cable 198 is wound again as the tension force is released from the cable 198, enabling the pectoralis major muscle piece 116 to return to its position over the breast implant 120.

In some embodiments, the cavity can be rectangular in shape. In some embodiments, the cavity may be circular, square, triangular, or any other reasonable shape. In some embodiments, the cable system can be disposed underneath the breast implant. The cavity 195 can be disposed inferior and lateral to the sternal area and the cover is flush with the surface of the model.

The cable 198 may connect a back portion of the pectoralis major muscle piece 116. The cable 198 may be elongated under tension force and compressed when tension is released. The cable 198 may be retractable back into the cavity when released (also shown in FIG. 4C). The cable 198 can connect to a single pectoralis major muscle piece 116 and elongates when the pectoralis major muscle piece 116 is contracted (e.g., lifted or pulled back).

When the cable 198 is in tension, the pectoralis major muscle piece 116 can be shortened or otherwise moved above the breast implant 120 such that the breast implant is not fully covered by the pectoralis major muscle piece 116. This movement of the pectoralis major muscle piece 116 demonstrates the shortening or accidental over dissection of the sternal attachments of the pectoralis major muscle piece 116 that can occur during the procedure. The over dissection leads to retraction of the pectoralis major muscle piece 116 superiorly on the chest. This retraction is often referred to as “window shading.” The movement of the pectoralis major muscle piece 116 can also demonstrate “animation deformities,” which is a common complication in sub-pectoral breast reconstruction. Additionally, in some embodiments, the model is used to educate the patient on the best ways to avoid these animation deformities. The cable system (e.g., cavity 195, cable 198, and ring 192) illustrates a precise demonstration on “window shading” and “animation deformities,” which are two common complications that can occur during breast augmentation or reconstruction resulting in detachment or scarring of the pectoralis major.

The cable 198 may be attached to the back portion of the pectoralis major muscle piece 116 by means of a clip, clasp, hook, staple, pin, or any reasonable connection thereof. Additionally, the cable 198 may be attached to a medial and proximal portion of the pectoralis major muscle piece 116. In some embodiments, the cable 198 may be attached to a medial and distal portion of the pectoralis major muscle piece. The cable system can include both stretchable and fixed components. In some embodiments, the cable 198 may be spring loaded. In some embodiments, the cable system may include more than one cable 198.

FIG. 4C is another example of the cavity 195 and cable 198 demonstrating the window shading effect of FIG. 4B. Window shading may be demonstrated by pulling the tethered lower portion or edge 119 of the pectoralis major muscle piece 116 away from the chest wall surface 104 to release the direct sternal attachment, and sliding the lower portion or edge 119 of the pectoralis major muscle piece 116 up onto the chest wall surface 104 in the direction of the collar bone. The teaching model 100 may thus be used to demonstrate the decreased surface area coverage of the pectoralis major muscle piece 116 on the chest wall surface 104 when window shading occurs. In some embodiments, the female torso 102 can include an umbilicus 199 for securing a skin tissue piece to the rectus abdominus major muscles 140.

FIG. 4D illustrates the cosmetic abnormalities resulting from the tearing or detachment of the pectoralis major muscle pieces 116. In this example, a dimple or crease 118 may be seen on the breast after the procedure. The crease 118 may not be seen until the patient contracts the pectoralis major muscle 116. In some embodiments, the crease 118 becomes more noticeable when the patient contracts their pectoralis major muscle 116.

The female torso may include hook members 187, 188 (e.g., surface pegs) for attachment of the rectus abdominus major muscles 142, 144.

Educating a Patient about Symmastia

FIG. 4E is a front view of the teaching model in FIG. 2E illustrating how the teaching model may be used to demonstrate the condition of symmastia, in accordance with some embodiments of the present disclosure. In accordance with some embodiments, as illustrated in FIG. 4E, the teaching model 100 may be used to demonstrate the condition of symmastia which is a complication of breast implant surgery in which there has been damage to the soft tissues of the breast or muscle, thereby causing the implant to develop a medial malposition. As illustrated, medical malposition may occur when the implant 120 slides underneath the pectoralis major muscle piece 116 and crosses a midline as illustrated by the implant 120A in dashed lines. This occurs for example, when pectoralis major muscle piece 116 is detached from the sternum and retracts back, similar to window shading, and the implant 120 slides underneath the pectoralis major muscle piece 116 to a position (e.g., a medial position, such as where implant 120A is located) overlapping a midline defined by the sagittal plane of the female-shaped torso 102.

Symmastia may be demonstrated by pulling the tethered lower portion or edge 119 of the pectoralis major muscle piece 116 away from the chest wall surface 104 to release the direct sternal attachment, and sliding the lower portion or edge 119 of the pectoralis major muscle piece 116 up onto the chest wall surface 104 in the direction of the collar bone. The implant 120 may then be slid in the cavity between the pectoralis major muscle piece 116 and the chest wall surface 104 to a position that crosses the midline, as illustrated in FIG. 4E.

Educating a Patient about Transfer of Autologous Fat from the Abdominal Area for Breast Reconstruction.

In accordance with some embodiments, the teaching model 100 may be used to demonstrate how a breast deformity may be corrected through the injection of autologous fat into the breast tissue or chest to correct soft tissue deformities or add volume. FIG. 5 is a front view illustrating introduction of autologous fat from underneath the abdominal tissue piece 134 into the breast tissue piece 112, in accordance with some embodiments of the present disclosure.

As illustrated in FIG. 5, the abdominal tissue piece 134 may include a hole 132 extending therethrough at a position on the female-shaped torso corresponding to a location of the belly button. Fat grafting to the chest and breast has become an integral part of breast augmentation, breast reconstruction, and breast revision procedures. During these procedures, fat may be harvested from a distant location on the body, processed, and grafted to areas that need soft tissue coverage.

The teaching model 100 may further be used to demonstrate a procedure in which the autologous fat may be injected into the breast tissue directly at the breast level. For example, the mastectomy breast tissue piece 113 may include one or more injection sites 115 for demonstrating where fat may be introduced into breast tissue from tissue harvested from other parts of the body. In some embodiments, the physician educated the patient on fat grafting by utilizing these injection sites 115 as they are small holes present in the fabric layer representing skin. In some embodiments, the demonstration may include placing a small liposuction cannula, straw, etc., to demonstrate where fat will be placed into a patient to add shape, volume, and/or soft tissue coverage.

The one or more injection sites 115 openings illustrated on the teaching model 100 are representative of areas where fat may be injected during a simulated surgical procedure. Patients, staff, residents, and medical students can understand how and where fat may be placed to correct soft tissue deficiencies. The typical locations used to inject fat into the breast or chest are along the inframammary fold and the lateral and superior breast and chest. The portals are representative of how the procedure is done, and help to demonstrate where and why fat grafting may be performed.

In some embodiments, the teaching model may also demonstrate soft-tissue thickness (also commonly referred to as pinch thickness). This demonstration is primarily useful in demonstrating pre-operatively the limitations of the procedure and the potential for visibility or palpability around the entire breast.

Educating a Patient about a Tummy Tuck Procedure

In accordance with some embodiments, the teaching model 100 may be used to demonstrate what occurs during surgical procedures to the abdomen. In particular, the teaching model 100 may be used to demonstrate an abdominoplasty or tummy tuck procedure.

In order to demonstrate the tummy tuck procedure, the abdominal tissue piece 134 may be elevated at its free end 147 to reveal the underlying pair of rectus muscle pieces 142, 144. In some aspects, the pair of rectus muscle pieces 142, 144 may be positioned spaced apart from each other to illustrate a diastasis condition commonly occurring during weight gains, weight losses and most often pregnancy. The diastasis may occur as a result of the pair of rectus muscle pieces 142, 144 being stretched and pulled away from each other. A repair of the diastasis condition may be demonstrated using the teaching model 100 by pulling the pair of rectus muscle pieces 142, 144 towards each other and illustrating how the pair of rectus muscle pieces 142, 144 may be sewn together at a first position above the belly button, and at a second position below the belly button to repair the diastasis condition. The abdominal tissue piece 134 may then be pulled and stretched over the pair of rectus muscle pieces 142, 144 and tucked inwards towards the pair of rectus muscle pieces 142, 144 to demonstrate the tummy tuck.

Educating a Patient about Use of Abdominal Wall Support with A-Cellular Dermal Matrixes (ADM)

In some embodiments, the teaching model 100 may be utilized to demonstrate use of abdominal wall support with ADM.

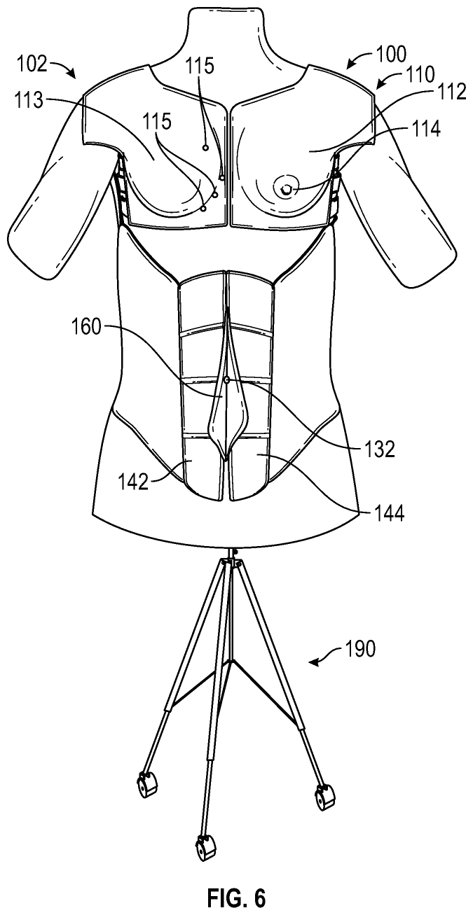

For example, the teaching model 100 may be utilized to demonstrate scenarios in which abdominal wall repair is necessary, as well as what occurs during the abdominal wall repair. FIG. 6 is a front view illustrating repair to an abdominal wall surface, in accordance with some embodiments of the present disclosure.

In these embodiments, the abdominal tissue piece 134 may be detached from the abdominal wall surface 106 of the female-shaped torso 102. The patient may be educated that a condition in which a portion of muscle missing from one or both of the pair of rectus muscle pieces 142, 144 may have occurred as a result of the aforementioned breast reconstruction using autologous tissue. The teaching model 100 may thus be used to demonstrate how a gap or a soft tissue defect between the pair of rectus muscle pieces 142, 144 may be repaired by positioning a support fabric piece 160 in the gap between the pair of rectus muscle pieces 142, 144 and stitching or otherwise coupling the support fabric piece 160 to the pair of rectus muscle pieces 142 at the location of the gap to provide support the abdominal wall surface.

Advantageously, patients are able to develop an understanding of some of the complications resulting from breast reconstruction surgery, as well as surgical procedures to correct these complications. In some embodiments, the teaching model 100 may be used to demonstrate a procedure to correct or repair a condition in which a patient has a hernia. In these embodiments, the support fabric piece 160 may be placed on top of and overlaying the pair of rectus muscle pieces 142, 144 at the location of the gap to provide support the abdominal wall surface.

Educating a Patient about Breast Reconstruction Using Autologous Tissue

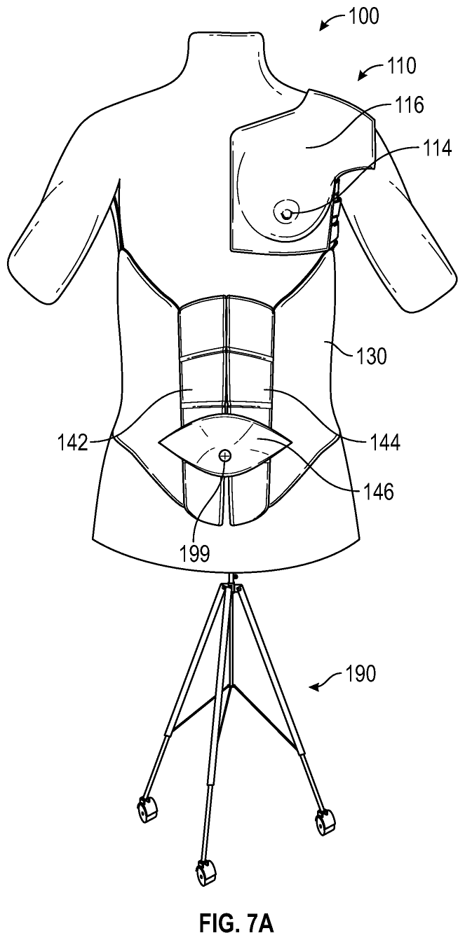

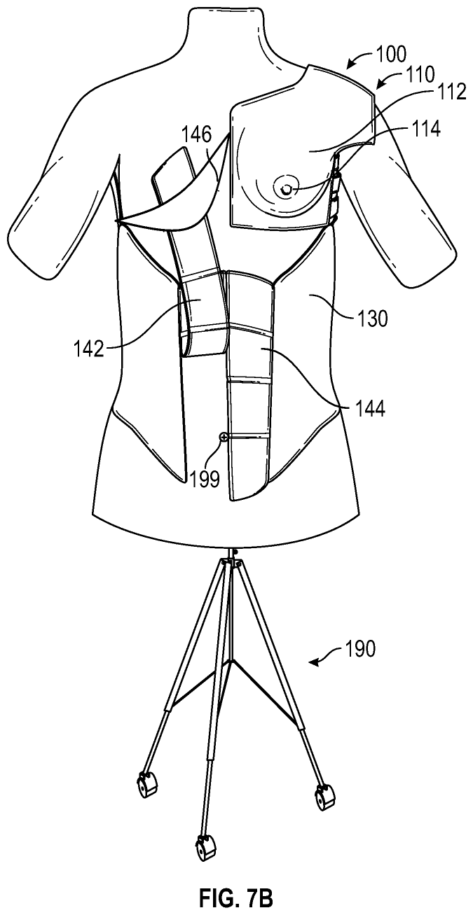

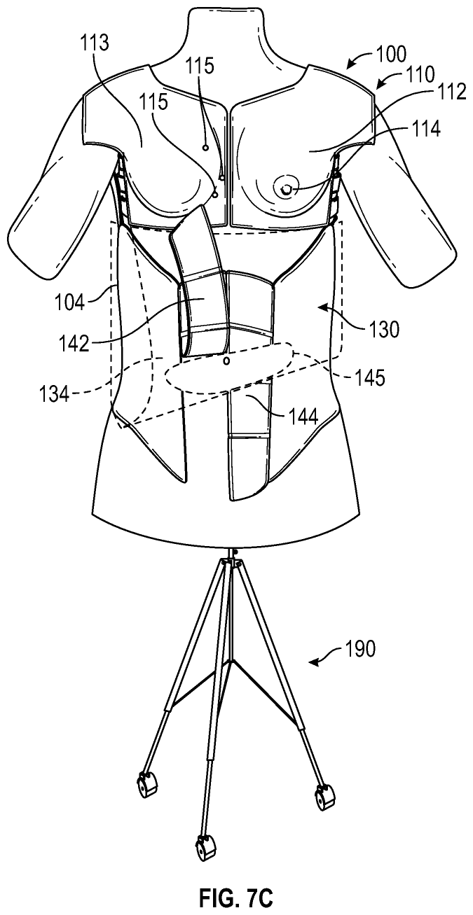

In some embodiments, the teaching model 100 may be used to demonstrate breast reconstruction using autologous tissue. FIGS. 7A and 7B are front views illustrating breast reconstruction using autologous tissue, in accordance with some embodiments of the present disclosure.

For example, FIG. 7A illustrates a separate detachable abdominal soft tissue flap 146 attached to one or the pair of rectus abdominus major muscles 142, 144 to demonstrate autologous breast reconstruction. A small strip of fabric is provided to demonstrate acellular dermal matrix (ADM) that may be used in the soft tissue support of the abdominal wall when required. Additionally, the detachable abdominal soft tissue piece 146 may connect or otherwise be disposed around an umbilicus 199. The abdominal soft tissue piece 146 may disconnect from the umbilicus 199 while still being attached to one or both of the pair of rectus abdominus major muscles 142, 144. These features can be implemented in any of the embodiments disclosed herein.

FIG. 7B illustrates a separate detachable abdominal soft tissue flap 146 being lifted and folded into the breast region to construct a new breast flap. As shown in this embodiment, the abdominal soft tissue flap 146 can be disconnected from the umbilicus 199 and remains coupled to the rectus abdominus major muscle 142. The rectus abdominus major muscle 142 may then be used to demonstrate how a portion of the rectus muscle piece 142 may be pulled and folded upwards towards the abdominal wall surface 103 together with the abdominal soft tissue flap 146 to form tissue for the mastectomy breast piece.

Optionally, the abdominal soft tissue flap 146 may also demonstrate the flap is utilized based on the blood supply of the muscle by demonstrating that the muscle itself can pivot, rotate, and be used to create a breast mound into their soft tissue to create a breast. Additionally, in some embodiments, the demonstration can show the visualization that by taking an abdominal muscular strip, the patient may be left with a weakened abdominal region in which a soft tissue strip may be implemented to aid in abdominal support.

As illustrated in FIG. 7C, the teaching model 100 may further include a mastectomy breast piece 113 having a decreased or lack of filling material therein. In order to illustrate breast reconstruction using autologous tissue, the abdominal tissue piece 134 may be elevated at its free end to reveal the underlying pair of rectus abdominus major muscles 142, 144.

In some embodiments, the pair of rectus muscle pieces 142, 144 may be utilized to demonstrate how each of the rectus muscle pieces 142, 144 have a dual blood supply which allows them to feed the breast tissue during breast reconstruction. In particular, the teaching model 100 may be used to demonstrate that blood vessels of the blood supply of the rectus muscle piece 142 may be paired with a portion of the abdominal tissue piece 134 and inserted into the breast component 110 to reconstruct the mastectomy breast piece 113.

For example, as illustrated in FIG. 7C, skin and fat which are removed from a donor site 145 of the abdominal tissue piece 134, along with the blood vessels of the rectus muscle piece 142, may be moved or swung upward into position in the breast component 110 to reconstruct the absent breast tissue post mastectomy to create breast tissue piece 113. Accordingly, the teaching model 100 may be used to demonstrate what occurs during a Deep Inferior Epigastric Perforator (DIEP) flap procedure. In the DIEP flap procedure, blood vessels called deep inferior epigastric perforators (including skin and fat connected to these blood vessels) can be transferred from the lower abdomen to the chest in order to reconstruct a breast after mastectomy without the sacrifice of any of the abdominal muscles.

### Fabric Loops and Hook Members for Movement of Tissue and Muscle Pieces

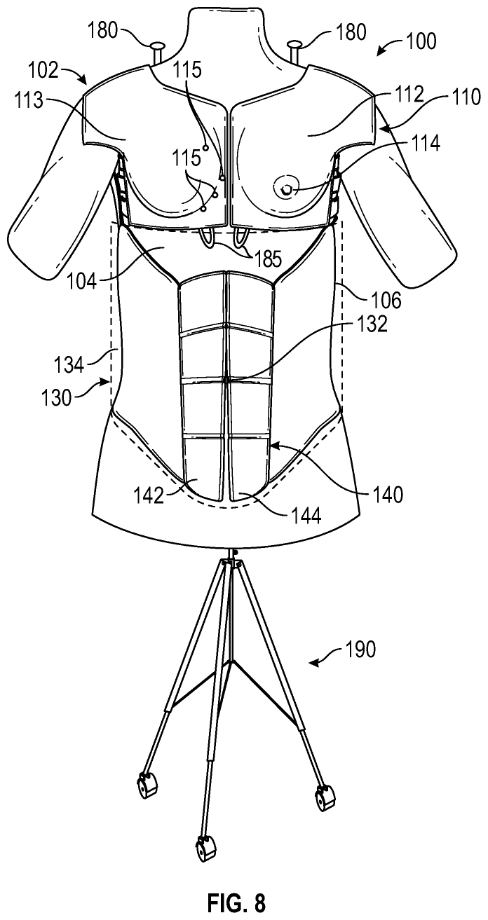

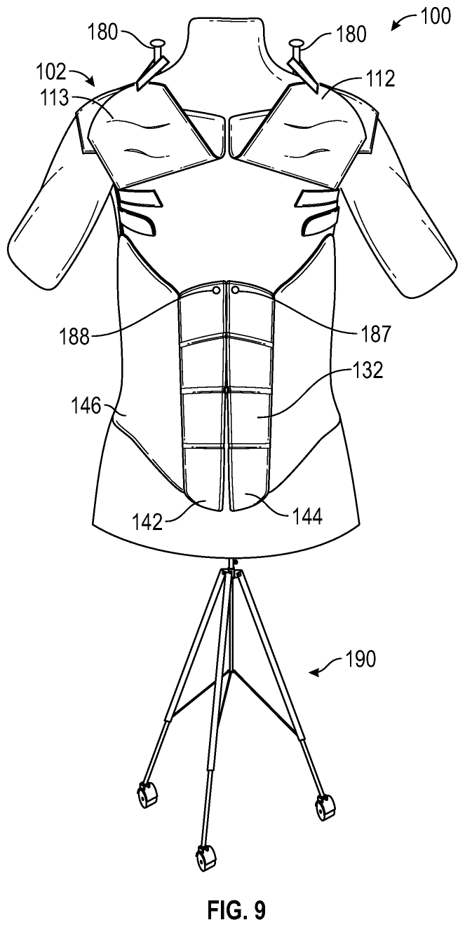

In some embodiments, the model can comprise fabric loops on the breast tissue pieces and hook members on the torso. FIG. 8 and FIG. 9 are front views of the teaching model in FIG. 2B illustrating hook members 180 and fabric loops 185 to reposition and secure the first breast tissue piece in a folded position against the torso. According to various embodiments of the present disclosure, a method of assembling an anatomical teaching model 100 for demonstrating and teaching the principals of breast and abdominal augmentation/reconstruction procedures may include providing the female-shaped torso 102 with breast flaps 112, 113.

Hook members 180 can be placed on a front-facing position of the top portion of the female-shaped torso (e.g., on the shoulders above where a clavicle would be) to allow temporary lifting of breast flaps 112, 113. In some embodiments, hook members 180 are placed on a back-facing position of the top portion of the female-shaped torso (e.g., on the shoulders above where a scapula would be) to allow temporary lifting of breast flaps 112, 113. The repositioning and securing of the first breast tissue piece aids in the demonstration of chest wall musculature and deep skin and tissue education. In some embodiments, the hook members 180 are pegs, pins, clips, or clasps.

In some embodiments, fabric loops 185 can be disposed on an inferior portion of the breast flaps 112, 113. The fabric loops are configured to engage the hook member thereby de-coupling the breast tissue piece from the pectoralis major muscle 116. Therefore, when the breast flap 112, 113 is lifted, it can be secured out of the way to facilitate the demonstration of the chest wall musculature. In some embodiments, the loops 185 are made from plastic, elastic, rubber, or any suitable material thereof. In some embodiments, the pegs may be plastic or metal extrusions, hooks, or clamps.

As depicted in the various embodiments described herein, the method may further include removably attaching a pectoralis major muscle piece 116 to the chest wall surface 104. wherein pectoralis major muscle piece 116 and the breast tissue piece 112 are repositionable relative to one another and relative to the torso. In some embodiments, at least one of the pectoralis major muscle pieces 116 are removably attached to the torso 102 using at least one fastener selected from the group consisting of a hook and loop fastener, a grommet fastener, a snap fastener, and a combination thereof.

In some embodiments, the model can comprise hook members on the torso to permit or accommodate rotation of rectus abdominus major muscles. The method may further include removably attaching the pair of rectus muscle pieces 142, 144 to the abdominal wall surface 106. As described above, the pair of rectus muscle pieces 142, 144 may include two sections of material positionable symmetrically about a sagittal plane of the torso 102.

In some embodiments, at least one of the pair of rectus muscle pieces 142, 144 or the abdominal tissue piece 134 are removably attached to the female-shaped torso 102 using at least one fastener selected from the group consisting of a tethering fastener, a hook and loop fastener, a grommet fastener, a snap fastener, and a combination thereof.

In some embodiments, the hook members 187, 188 can be placed an upper portion of the rectus muscle pieces region on a lower portion of the female-shaped torso 102 to allow rotation of the rectus muscle pieces 142, 144. In some embodiments, the rectus muscle pieces 142, 144 are secured around the hook members 187, 188 so that the rectus muscle pieces 142, 144 are removably coupled to the female-shaped torso 102. In some embodiments, the rotation of the pair of rectus muscle pieces 142, 144 demonstrate the surgical procedure or complication being illustrated. In some embodiments, the hook members 187, 188 may be plastic or metal. In some embodiments, the hook members 187, 188 are pegs, hooks, pins, clips, or clasps. In some embodiments, the rectus muscle pieces 142, 144 are formed of a stretchable fabric material.

In some embodiments, the hook members 187, 188 are configured to allow a 360 degree rotation of the rectus muscle pieces 142, 144.

It can therefore be seen that the teaching model with the modifications described to include an abdominal teaching component, is an important tool that can improve both patient and physician education in breast augmentation and breast reconstruction and may lead to improved surgical outcomes and reduced reoperation rates. An improved educational experience may help patients become better informed and therefore better able to make informed consent. The breast implant and abdominal teaching model is designed as an educational tool to enhance the hands on teaching of plastic surgery residents, and young plastic surgeons. In addition, it advantageously provides a visual three-dimensional anatomic model for use during patient consultations for procedures including, but not limited to breast augmentation, breast reconstruction, breast implant revision or corrective procedures, breast reconstruction using autologous tissue from the abdomen, fat transfer procedures, the repair of abdominal hernias and soft tissue defects, as well as abdominoplasty procedures. The teaching model of the various embodiments described herein is an educational tool that helps create better informed and engaged patients: pre-operatively, post-operatively, and at every follow-up visit for years to come. For these reasons, the present disclosure represents a significant advancement in the art, which has substantial commercial merit.

Various examples of aspects of the disclosure are described as numbered clauses (1, 2, 3, etc.) for convenience. These are provided as examples and do not limit the subject technology. Identification of the figures and reference numbers are provided below merely as examples for illustrative purposes, and the clauses are not limited by those identifications.

Clause 1. A bilateral anatomical teaching model for demonstrating a breast surgical procedure, the bilateral anatomical teaching model comprising: a female-shaped torso including a chest wall surface; a pair of pectoralis major muscle pieces comprising a left pectoralis major muscle piece and a right pectoralis major muscle piece that are positionable over the chest wall surface; a first breast tissue piece that is positionable over the left pectoralis major muscle piece, wherein the first breast tissue piece comprises a first pocket to accommodate an implant; and a second breast tissue piece that is positionable over the right pectoralis major muscle piece, wherein the second breast tissue piece comprises a second pocket to accommodate an implant.

Clause 2. The bilateral anatomical teaching model of Clause 1, further comprising a breast implant for demonstrating a breast augmentation procedure using the first or the second breast tissue piece.

Clause 3. The bilateral anatomical teaching model of any of the preceding Clauses, wherein the first breast tissue piece represents a breast augmentation and the second breast tissue piece represents a breast reconstruction, or wherein the first breast tissue piece represents a breast reconstruction and the second breast tissue piece represents a breast augmentation.

Clause 4. The bilateral anatomical teaching model of any of the preceding Clauses, further comprising a first breast implant having a first size and a second breast implant having a second size, wherein the first and second pockets are configured to receive at least one of the first breast implant and the second breast implant.

Clause 5. The anatomical teaching model any of the preceding Clauses, wherein the torso comprises a fastener for coupling components thereto.

Clause 6. The anatomical teaching model of Clause 5, wherein the fastener comprises Velcro extending across an anterior surface of the torso.

Clause 7. The anatomical teaching model any of the preceding Clauses, wherein the torso comprises a hook member for coupling components thereto.

Clause 8. The anatomical teaching model of Clause 1, wherein the hook member comprises a peg.

Clause 9. The anatomical teaching model of Clause 8, wherein the peg extends from a shoulder region of the torso.

Clause 10. The anatomical teaching model of Clause 1, wherein at the least one fastener comprises a plurality of fasteners positioned along an anterior portion of an upper region of the torso.

Clause 11. The anatomical teaching model of any of the preceding Clauses, further comprising a serratus muscles piece disposed on the chest wall surface and at least partially underneath the pectoralis major muscle piece.

Clause 12. The anatomical teaching model of any of the preceding Clauses, further comprising a capsule pocket configured to be inserted between the pectoralis major muscle piece and the chest wall surface, the capsule pocket having an opening for insertion of a breast implant.

Clause 13. A method of demonstrating a breast surgical procedure on a bilateral anatomical teaching model, the method comprising: performing a first breast procedure on a first side of a bilateral anatomical teaching model to demonstrate an aspect of a breast procedure; and performing a second breast procedure on a second side of the teaching model to demonstrate another aspect of a breast procedure, wherein the first breast procedure is different than the second breast procedure.

Clause 14. The method of Clause 13, further comprising inserting an implant into a first pocket disposed on the posterior side of a breast tissue piece.

Clause 15. The method of Clause 13, wherein the first side of the bilateral anatomical teaching model is a left side, and wherein the second side of the bilateral anatomical teaching model is a right side, or wherein the first side of the bilateral anatomical teaching model is a right side, and wherein the second side of the bilateral anatomical teaching model is a left side.

Clause 16. The method of any of the preceding Clauses 13-15, further comprises demonstrating, the first breast procedure and the second breast procedure, wherein the first breast procedure is a breast augmentation and wherein the second breast procedure is a breast reconstruction, or wherein the first breast procedure and the second breast procedure both demonstrate breast reconstructions, or wherein the first breast procedure and the second breast procedure both demonstrate breast augmentations.

Clause 17. The method of any of the preceding Clauses 13-16, further comprising coupling components to the torso by means of a fastener.

Clause 18. The method of any of the preceding Clauses 13-17, further comprising coupling components to the torso by means of a hook member.

Clause 19. The method of Clause 13, further comprising positioning a plurality of fasteners positioned along an anterior portion of an upper region of the torso.

Clause 20. The method of any of the preceding Clauses 13-19, further comprising disposing a serratus muscles piece on the chest wall surface and at least partially underneath the pectoralis major muscle piece.

Clause 21. The method of any of the preceding Clauses 13-20 further comprising configuring a capsule pocket to be inserted between the pectoralis major muscle piece and the chest wall surface, the capsule pocket having an opening for insertion of a breast implant.

Clause 22. An anatomical teaching model for demonstrating a breast surgical procedure, the anatomical teaching model comprising: a female-shaped torso including a chest wall surface; a pair of pectoralis major muscle pieces comprising a left pectoralis major muscle piece and a right pectoralis major muscle piece that are positionable over the chest wall surface; a first breast tissue piece that is positionable over one of the left or right pectoralis major muscle pieces; a hook member extending from an upper portion of the female-shaped torso; and a first fabric loop coupled to the first breast tissue piece for permitting repositioning and securing of the first breast tissue piece in a folded position against the torso.

Clause 23. The anatomical teaching model of Clause 22, wherein the first breast tissue piece comprises a first pocket disposed on the posterior side of the breast tissue piece, the first pocket configured to accommodate an implant.

Clause 24. The anatomical teaching model of Clause 23, wherein the first pocket is configured to demonstrate pre-pectoral breast reconstruction.

Clause 25. The anatomical teaching model of Clause 23, wherein the first pocket is configured to demonstrate sub-glandular breast augmentation.

Clause 26. The anatomical teaching model of Clause 22, wherein the hook member comprises a peg, a pin, a clip, or a clasp.

Clause 27. The anatomical teaching model of Clause 22, wherein the first fabric loop is configured to engage the hook member thereby de-coupling the first breast tissue piece from the pectoralis major muscle.

Clause 28. The anatomical teaching model of Clause 22, wherein at least one of the pair of pectoralis major muscle pieces, or the first breast tissue piece is attached to the torso using at least one fastener selected from the group consisting of a hook and loop fastener, a grommet fastener, or a snap fastener.

Clause 29. The anatomical teaching model of Clause 28, wherein at the least one fastener comprises a plurality of fasteners positioned along at least one of the sternal border, the clavicle, the axilla, or the anterior axillary line.

Clause 30. The anatomical teaching model of any of Clauses 22-29, wherein one or more of the pair of pectoralis major muscle pieces attaches to the chest wall surface at a plurality of positions.

Clause 31. The anatomical teaching model of any of Clauses 22-30, further comprising a serratus muscles piece disposed on the chest wall surface and at least partially underneath the pectoralis major muscle piece.

Clause 32. The anatomical teaching model of any of Clauses 22-31, further comprising a capsule pocket configured to be inserted between the pectoralis major muscle piece and the chest wall surface, the capsule pocket having an opening for insertion of an implant.

Clause 33. The anatomical teaching model of any of Clauses 22-32, wherein the breast tissue piece comprises an anterior fabric layer, a posterior fabric layer coupled to the anterior fabric layer, and a soft tissue filling disposed between the anterior and posterior fabric layers.

Clause 34. A method of repositioning one or more breast flaps, the method comprising: providing an anatomical teaching model, wherein the anatomical teaching model includes: a female-shaped torso including a chest wall surface; a pair of pectoralis major muscle pieces comprising a left pectoralis major muscle piece and a right pectoralis major muscle piece that are positionable over the chest wall surface; a first breast tissue piece that is positionable over one of the left or right pectoralis major muscle pieces; a hook member extending from an upper portion of the female-shaped torso; and a first fabric loop coupled to the first breast tissue piece; engaging the first fabric loop with the hook member, wherein the first fabric loop is disposed around the hook member, and securing of the first breast tissue piece in a folded position against the torso, thereby allowing repositioning of the first breast tissue piece.

Clause 35. The method of Clause 34, further comprising attaching at least one of the pair of pectoralis major muscle pieces, or the first breast tissue piece to the torso using at least one fastener selected from the group consisting of a hook and loop fastener, a grommet fastener, or a snap fastener.

Clause 36. The method of Clause 34, further comprising positioning a plurality of fasteners along at least one of the sternal border, the clavicle, the axilla, or the anterior axillary line.

Clause 37. The method model of any of Clauses 34-36, further comprising attaching one or more of the pair of pectoralis major muscle pieces to the chest wall surface at a plurality of positions.

Clause 38. The method of any of Clauses 34-37, further comprising disposing a serratus muscles piece on the chest wall surface and at least partially underneath the pectoralis major muscle piece.

Clause 39. The method of any of Clauses 34-38, further comprising inserting a capsule pocket between the pectoralis major muscle piece and the chest wall surface, the capsule pocket having an opening for insertion of an implant.

Clause 40. An anatomical teaching model for demonstrating an autologous fat transfer procedure, the anatomical model comprising: a female-shaped torso including a chest wall surface; a pair of pectoralis major muscle pieces comprising a left pectoralis major muscle piece and a right pectoralis major muscle piece that are positionable over the chest wall surface; a first breast tissue piece that is positionable over the pectoralis major muscle; and one or more injection sites coupled to the first breast tissue piece for demonstrating injection sites for an autologous fat transfer procedure.

Clause 41. The anatomical teaching model of Clause 40, wherein the first breast tissue piece comprises a first pocket disposed on the posterior side of the breast tissue piece, the first pocket configured to accommodate an implant.

Clause 42. The anatomical teaching model of any of Clauses 40 to 41, wherein the one or more injection sites demonstrate autologous fat transfer.

Clause 43. The anatomical teaching model of any of Clauses 40 to 42, wherein the one or more injection sites are disposed on a left portion and a right portion of the first breast tissue piece.

Clause 44. The anatomical teaching model of any of Clause 40 to 43, wherein at least one of the pair of pectoralis major muscle pieces, or the first breast tissue piece is attached to the female-shaped torso using at least one fastener selected from the group consisting of a hook and loop fastener, a grommet fastener, or a snap fastener.

Clause 45. The anatomical teaching model of Clause 44, wherein at the least one fastener comprises a plurality of fasteners positioned along at least one of the sternal border, the clavicle, the axilla, or the anterior axillary line.

Clause 46. A method of demonstrating an autologous fat transfer procedure, the method comprising: providing an anatomical teaching model comprising: a female-shaped torso including a chest wall surface; a pair of pectoralis major muscle pieces comprising a left pectoralis major muscle piece and a right pectoralis major muscle piece that are positionable over the chest wall surface; and a first breast tissue piece that is positionable over the pectoralis major muscle; and demonstrating injection sites for an autologous fat transfer procedure by one or more injection sites coupled to the first breast tissue piece.

Clause 47. The method of Clause 46, further comprising inserting an implant into a first pocket disposed on the posterior side of the breast tissue piece.

Clause 48. The method of any of Clauses 46 to 47, further comprising disposing the one or more injection sites on a left portion and a right portion of the first breast tissue piece.

Clause 49. The method of any of Clauses 46 to 48, further comprising attaching at least one of the pair of pectoralis major muscle pieces, or the first breast tissue piece to the female-shaped torso using at least one fastener selected from the group consisting of a hook and loop fastener, a grommet fastener, or a snap fastener.

Clause 50. The method of Clause 49, further comprising positioning a plurality of fasteners along at least one of the sternal border, the clavicle, the axilla, or the anterior axillary line.

Clause 51. An anatomical teaching model for demonstrating an autologous tissue reconstruction procedure, the anatomical model comprising: a female-shaped torso including a chest wall surface and an abdominal wall surface; a pair of pectoralis major muscle pieces comprising a left pectoralis major muscle piece and a right pectoralis major muscle piece that are positionable over the chest wall surface; a first breast tissue piece that is positionable over one of the left or right pectoralis major muscle pieces; a rectus muscle piece attachable to the abdominal wall surface; and an abdominal skin tissue piece attachable to the rectus muscle piece, the abdominal skin tissue piece and the rectus muscle piece being displaceable away from the abdominal wall surface toward a position in which the abdominal skin flap is adjacent to the first breast tissue piece to demonstrate the autologous tissue reconstruction procedure.

Clause 52. The anatomical teaching model of Clause 51, wherein the first breast tissue piece comprises a first pocket disposed on the posterior side of the breast tissue piece, the first pocket configured to accommodate an implant.

Clause 53. The anatomical teaching model of any of Clauses 51 to 52, wherein the rectus muscle piece comprising two sections of material positionable symmetrically about a sagittal plane of the female-shaped torso.

Clause 54. The anatomical teaching model of any of Clauses 51 to 53, wherein the abdominal skin tissue piece can illustrate a cool-sculpting procedure, an abdominoplasty, a repair of umbilical hernias, and any other suitable teaching procedure thereof.

Clause 55. The anatomical teaching model of any of Clauses 51 to 54, wherein at least one of the pair of pectoralis major muscle pieces, the first breast tissue piece, the rectus muscle piece, or the abdominal skin tissue piece is attached to the female-shaped torso using at least one fastener selected from the group consisting of a hook and loop fastener, a grommet fastener, or a snap fastener.

Clause 56. The anatomical teaching model of Clause 55, wherein at the least one fastener comprises a plurality of fasteners positioned along at least one of the sternal border, the clavicle, the axilla, or the anterior axillary line.

Clause 57. The anatomical teaching model of any of Clauses 55 to 56, wherein at the least one fastener comprises a tethering fastener.

Clause 58. The anatomical teaching model of any of Clauses 51-57, further comprising a serratus muscles piece disposed on the chest wall surface and at least partially underneath the pectoralis major muscle piece.

Clause 59. The anatomical teaching model of Clause 58, wherein at least one of the pectoralis minor muscle piece or the serratus muscles piece are removably attachable to the female-shaped torso using at least one fastener selected from the group consisting of a hook and loop fastener, a grommet fastener, or a snap fastener.

Clause 60. The anatomical teaching model of any of Clauses 51-59, further comprising inframammary fold element positioned on the chest wall between the pectoralis major muscle piece and the rectus muscle pieces.

Clause 61. The anatomical teaching model of any of Clauses 51-60, further comprising a capsule pocket configured to be inserted between the pectoralis major muscle piece and the chest wall surface, the capsule pocket having an opening for insertion of an implant.

Clause 62. The anatomical teaching model of any of Clauses 51-61, wherein the breast tissue piece comprises an anterior fabric layer, a posterior fabric layer coupled to the anterior fabric layer, and a soft tissue filling disposed between the anterior and posterior fabric layers.

Clause 63. A method of demonstrating an autologous tissue reconstruction procedure, the method comprising: providing an anatomical teaching model comprising: a female-shaped torso including a chest wall surface and an abdominal wall surface; a pair of pectoralis major muscle pieces comprising a left pectoralis major muscle piece and a right pectoralis major muscle piece that are positionable over the chest wall surface; a first breast tissue piece that is positionable over one of the left or right pectoralis major muscle pieces; and a rectus muscle piece attachable to the abdominal wall surface; and performing an abdominal procedure, wherein an abdominal skin tissue piece is attachable to the rectus muscle piece, the abdominal skin tissue piece and the rectus muscle piece being displaceable away from the abdominal wall surface toward a position in which the abdominal skin flap is adjacent to the first breast tissue piece to demonstrate the autologous tissue reconstruction procedure.

Clause 64. The method Clause 63, further comprising disposing a first pocket on the posterior side of the breast tissue piece, the first pocket configured to accommodate an implant.

Clause 65. The method any of Clauses 63 to 64, further comprising positioning two sections of material disposed on the rectus muscle piece about a sagittal plane of the female-shaped torso.

Clause 66. The method any of Clauses 63 to 65, further comprising performing an illustration of a plurality of procedures wherein the abdominal skin tissue piece can illustrate a non-surgical fat reduction procedure, an abdominoplasty, a repair of umbilical hernias, and any other suitable teaching procedure thereof.

Clause 67. The method any of Clauses 63 to 66, further comprising attaching at least one of the pair of pectoralis major muscle pieces, the first breast tissue piece, the rectus muscle piece, or the abdominal skin tissue piece to the female-shaped torso using at least one fastener selected from the group consisting of a hook and loop fastener, a grommet fastener, a snap fastener, and a combination thereof.

Clause 68. The anatomical teaching model of Clause 67, further comprising positioning a plurality of fasteners positioned along at least one of the sternal border, the clavicle, the axilla, or the anterior axillary line.

Clause 69. The method Clause 63-68, further comprising positioning an inframammary fold element on the chest wall between the pectoralis major muscle piece and the rectus muscle pieces.

Clause 70. The method Clause 63-69, further comprising configuring a capsule pocket to be inserted between the pectoralis major muscle piece and the chest wall surface, the capsule pocket having an opening for insertion of an implant.

Clause 71. An anatomical teaching model for demonstrating window-shading complications of a breast implant procedure, the anatomical model comprising: a female-shaped torso including a chest wall surface and an abdominal wall surface; a pair of pectoralis major muscle pieces; a first breast tissue piece that is positionable over the pectoralis major muscle piece; a pair of rectus muscle pieces attachable to the abdominal wall surface; and a coupling component attached to a lower, medial section of the pectoralis major muscle piece, the coupling component permitting elastic displacement of the pectoralis major muscle piece relative to the chest wall surface between a first position and a window-shaded position for demonstrating a window-shading complication.

Clause 72. The anatomical teaching model of Clause 71, wherein the breast tissue piece comprises a pocket disposed on the posterior side of the breast tissue piece, the first pocket configured to accommodate an implant.

Clause 73. The anatomical teaching model of any of Clauses 71 to 72, wherein the pair of rectus muscle pieces comprises two sections of material positionable symmetrically about a sagittal plane of the female-shaped torso.

Clause 74. The anatomical teaching model of any of Clauses 71 to 73, wherein the coupling component is disposed within a cavity.

Clause 75. The anatomical teaching model of any of Clauses 71 to 74, wherein the coupling component comprises a lanyard cable.

Clause 76. The anatomical teaching model of any of Clauses 71 to 75, wherein at least one of the pair of pectoralis major muscle pieces, the first breast tissue piece, or the pair of rectus muscle pieces is attached to the female-shaped torso using at least one fastener selected from the group consisting of a hook and loop fastener, a grommet fastener, or a snap fastener.

Clause 77. The anatomical teaching model of Clause 76, wherein at the least one fastener comprises a plurality of fasteners positioned along at least one of the sternal border, the clavicle, the axilla, or the anterior axillary line.

Clause 78. The anatomical teaching model of any of Clauses 71-77 further comprising inframammary fold element positioned on the chest wall between the pectoralis major muscle piece and the pair of rectus muscle pieces.

Clause 79. The anatomical teaching model of any of Clauses 71-78, further comprising a capsule pocket configured to be inserted between the pectoralis major muscle piece and the chest wall surface, the capsule pocket having an opening for insertion of an implant.

Clause 80. The anatomical teaching model of any of Clauses 71-79, wherein the breast tissue piece comprises an anterior fabric layer, a posterior fabric layer coupled to the anterior fabric layer, and a soft tissue filling disposed between the anterior and posterior fabric layers.

Clause 81. A method of demonstrating window-shading complications of a breast implant procedure comprising: providing an anatomical model comprising: a female-shaped torso including a chest wall surface and an abdominal wall surface; a pair of pectoralis major muscle pieces; a first breast tissue piece that is positionable over the pectoralis major muscle piece; a pair of rectus muscle pieces attachable to the abdominal wall surface; and attaching a coupling component to a lower, medial section of the pectoralis major muscle piece; elastically displacing the coupling component of the pectoralis major muscle piece relative to the chest wall surface between a first position and a window-shaded position for demonstrating a window-shading complication.

Clause 82. The method of Clause 81, further comprising disposing a first pocket on the posterior side of the breast tissue piece, the first pocket configured to accommodate an implant.

Clause 83. The method of any of Clauses 81 to 82, further comprising positioning two sections of material disposed on the rectus muscle piece about a sagittal plane of the female-shaped torso.

Clause 84. The method of any of Clauses 81 to 83, further comprising disposing the coupling component within a cavity.

Clause 85. The method of any of Clauses 81 to 84, further comprising attaching a lanyard cable to the coupling component.

Clause 86. The method of any of Clauses 81 to 85, further comprising attaching at least one of the pair of pectoralis major muscle pieces, the first breast tissue piece, or the pair of rectus muscle pieces to the female-shaped torso using at least one fastener selected from the group consisting of a hook and loop fastener, a grommet fastener, or a snap fastener.

Clause 87. The method of Clause 86, further comprising positioning a plurality of fasteners positioned along at least one of the sternal border, the clavicle, the axilla, or the anterior axillary line.

Clause 88. The method of Clause 81-87, further comprising disposing a serratus muscles piece on the chest wall surface and at least partially underneath the pair of pectoralis major muscle pieces.

Clause 89. The method of Clause 81-88, further comprising positioning an inframammary fold element on the chest wall between the pectoralis major muscle piece and the pair of rectus muscle pieces.

Clause 90. The method of Clause 81-89, further comprising configuring a capsule pocket to be inserted between the pectoralis major muscle piece and the chest wall surface, the capsule pocket having an opening for insertion of an implant. In some implants, modifications to the capsule can be demonstrated. In some embodiments, capsular contraction is demonstrated by a squeezing of the capsule which shows the firm implant. In some embodiments, a total capsulectomy, removal of an implant while leaving the capsule behind, popcorn capsulorrhaphy (i.e., using heat to hit portions of the capsule causing it to shrink and reduce its size), malposition of the capsule (e.g., lateral malposition, inferior malposition), sliding of the implant, etc. abnormalities may be demonstrated. In some embodiments, the model is used to demonstrate the corrections to the abnormalities. In some embodiments, capsular flaps, capsulotomy, capsulectomy, implant exchanges, neo subpectoral pocket (i.e., removing the implant and creating a new pocket).

Clause 91. An anatomical teaching model for demonstrating surgical procedure or complication, the anatomical model comprising: a female-shaped torso including a chest wall surface and an abdominal wall surface; at least one pectoralis major muscle piece that is positionable over the chest wall surface; at least one breast tissue piece that is positionable over the pectoralis major muscle; a pair of hook members extending anteriorly from a medial section of the torso; and a pair of rectus muscle pieces attachable to the torso using the pair of hook members, the pair of rectus muscles being rotatable for demonstrating the surgical procedure or complication.

Clause 92. The anatomical teaching model of Clause 91, wherein the first breast tissue piece comprises a first pocket disposed on the posterior side of the breast tissue piece, the first pocket configured to accommodate an implant.

Clause 93. The anatomical teaching model of any of Clauses 91 to 92, wherein the pair of rectus muscle pieces comprising two sections of material positionable symmetrically about a sagittal plane of the female-shaped torso.

Clause 94. The anatomical teaching model of any of Clauses 91 to 93, wherein the pair of rectus muscle are secured to a base portion.

Clause 95. The anatomical teaching model of any of Clauses 91 to 94, wherein the pair of hook members are configured to allow a 360 degree rotation of the pair of rectus muscle.

Clause 96. The anatomical teaching model of any of Clauses 91 to 95, wherein the pair of hook members is a peg, a hook, a pin, a clip, or a clasp.

Clause 97. The anatomical teaching model of any of Clauses 91 to 96, wherein the at least one of the pair of pectoralis major muscle pieces, the at least one breast tissue piece, or the pair of rectus muscle pieces is attached to the female-shaped torso using at least one fastener selected from the group consisting of a hook and loop fastener, a grommet fastener, or a snap fastener.

Clause 98. The anatomical teaching model of Clause 97, wherein at the least one fastener comprises a plurality of fasteners positioned along at least one of the sternal border, the clavicle, the axilla, or the anterior axillary line.

Clause 99. A method of demonstrating a surgical procedure or complication, the method including: providing an anatomical teaching model, the anatomical model comprising: a female-shaped torso including a chest wall surface and an abdominal wall surface; at least one pectoralis major muscle piece that is positionable over the chest wall surface; at least one breast tissue piece that is positionable over the pectoralis major muscle; and a pair of hook members extending anteriorly from a medial section of the torso; attaching a pair of rectus muscle pieces to the torso using the pair of hook members; and rotating the pair of rectus muscles for demonstrating the surgical procedure or complication.

Clause 100. The method of Clause 99, further comprising disposing a first pocket on the posterior side of the breast tissue piece, the first pocket configured to accommodate an implant.

Clause 101. The method of any of Clauses 99 to 100, further comprising positioning two sections of material disposed on the rectus muscle piece about a sagittal plane of the female-shaped torso.

Clause 102. The method of any of Clauses 99 to 101, further comprising securing the pair of rectus muscle to a base portion.

Clause 103. The method of any of Clauses 99 to 102, further comprising configuring the pair of hook members to allow a 360 degree rotation of the pair of rectus muscle.

Clause 104. The method of any of Clauses 99 to 103, further comprising attaching the at least one of the pair of pectoralis major muscle pieces, the at least one breast tissue piece, or the pair of rectus muscle pieces to the female-shaped torso using at least one fastener selected from the group consisting of a hook and loop fastener, a grommet fastener, or a snap fastener.

Clause 105. The method of Clause 104, further comprising positioning a plurality of fasteners positioned along at least one of the sternal border, the clavicle, the axilla, or the anterior axillary line.

The previous description is provided to enable any person skilled in the art to practice the various aspects described herein. While the foregoing has described what are considered to be the best mode and/or other examples, it is understood that various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the terms “a set” and “some” refer to one or more. Pronouns in the masculine (e.g., his) include the feminine and neuter gender (e.g., her and its) and vice versa. Headings and subheadings, if any, are used for convenience only and do not limit the embodiments disclosed herein.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. A phrase such an embodiment may refer to one or more embodiments and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A bilateral anatomical teaching model for demonstrating a breast surgical procedure, the bilateral anatomical teaching model comprising:
a female-shaped torso including a chest wall surface;
a pair of pectoralis major muscle pieces comprising a left pectoralis major muscle piece and a right pectoralis major muscle piece that are positionable over the chest wall surface;
a first breast tissue piece that is positionable over the left pectoralis major muscle piece, wherein the first breast tissue piece comprises a first pocket to accommodate an implant; and
a second breast tissue piece that is positionable over the right pectoralis major muscle piece, wherein the second breast tissue piece comprises a second pocket to accommodate an implant.

2. The bilateral anatomical teaching model of claim 1, further comprising a breast implant for demonstrating a breast augmentation procedure using the first or the second breast tissue piece.

3. The bilateral anatomical teaching model of claim 1, wherein the first breast tissue piece represents a breast augmentation and the second breast tissue piece represents a breast reconstruction, or wherein the first breast tissue piece represents a breast reconstruction and the second breast tissue piece represents a breast augmentation.

4. The bilateral anatomical teaching model of claim 1, further comprising a first breast implant having a first size and a second breast implant having a second size, wherein the first and second pockets are configured to receive at least one of the first breast implant and the second breast implant.

5. The anatomical teaching model of claim 1, wherein the torso comprises a fastener for coupling components thereto.

6. The anatomical teaching model of claim 5, wherein the fastener comprises Velcro extending across an anterior surface of the torso.

7. The anatomical teaching model claim 1, wherein the torso comprises a hook member for coupling components thereto.

8. The anatomical teaching model of claim 7, wherein the hook member comprises a peg.

9. The anatomical teaching model of claim 8, wherein the peg extends from a shoulder region of the torso.

10. The anatomical teaching model of claim 1, wherein the at least one fastener comprises a plurality of fasteners positioned along an anterior portion of an upper region of the torso.

11. The anatomical teaching model of claim 1, further comprising a serratus muscles piece disposed on the chest wall surface and at least partially underneath the pectoralis major muscle piece.

12. The anatomical teaching model of claim 1, further comprising a capsule pocket configured to be inserted between the pectoralis major muscle piece and the chest wall surface, the capsule pocket having an opening for insertion of a breast implant.

13. A method of demonstrating a breast surgical procedure on a bilateral anatomical teaching model, the method comprising:
performing a first breast procedure on a first side of a bilateral anatomical teaching model to demonstrate an aspect of a breast procedure; and
performing a second breast procedure on a second side of the teaching model to demonstrate another aspect of a breast procedure, wherein the first breast procedure is different than the second breast procedure.

14. The method of claim 13, further comprising inserting an implant into a first pocket disposed on the posterior side of a breast tissue piece.

15. The method of claim 13, wherein the first side of the bilateral anatomical teaching model is a left side, and wherein the second side of the bilateral anatomical teaching model is a right side, or wherein the first side of the bilateral anatomical teaching model is a right side, and wherein the second side of the bilateral anatomical teaching model is a left side.

16. The method of claim 13, wherein the first breast procedure is a breast augmentation and wherein the second breast procedure is a breast reconstruction, or wherein the first breast procedure and the second breast procedure both demonstrate breast reconstructions, or wherein the first breast procedure and the second breast procedure both demonstrate breast augmentations.

17. The method of claim 13, further comprising coupling components to the torso by means of a fastener.

18. The method of claim 13, further comprising positioning a plurality of fasteners positioned along an anterior portion of an upper region of the torso.

19. The method of claim 13, further comprising disposing a serratus muscles piece on the chest wall surface and at least partially underneath the pectoralis major muscle piece.

20. The method of claim 13 further comprising configuring a capsule pocket to be inserted between the pectoralis major muscle piece and the chest wall surface, the capsule pocket having an opening for insertion of a breast implant.
